(19) United States
(12) Patent Application Publication
(10) Pub. No.: US 2022/0100532 A1
(43) Pub. Date: Mar. 31, 2022

(54) TECHNOLOGY FOR TRANSFERRING IOMMU OWNERSHIP TO A NEW VERSION OF SYSTEM SOFTWARE

(71) Applicant: Intel Corporation, Santa Clara, CA (US)

(72) Inventors: Rupin Hemantkumar Vakharwala, Hillsboro, OR (US); Joseph Frank Cihula, Hillsboro, OR (US); Philip Ralph Lantz, Cornelius, OR (US); Utkarsh Yogeshkumar Kakaiya, Folsom, CA (US)

(21) Appl. No.: 17/032,020

(22) Filed: Sep. 25, 2020

(51) Int. Cl. G06F 9/445; G06F 21/79; G06F 12/06; G06F 13/28

(52) U.S. Cl. CPC G06F 9/44505; G06F 21/79; G06F 8/65; G06F 13/28; G06F 12/06

(57) ABSTRACT

A processor package comprises a processing core, a system agent, an input/output memory management unit (IOMMU), and transaction security circuitry (TSC) in at least one of the system agent and the IOMMU. The TSC determines whether ultra-protected memory (UPM) is enabled in a data processing system that comprises the processor package. The transaction security circuitry also determines whether an address for a memory access transaction in the data processing system falls within a UPM region within a physical address space of the data processing system. The transaction security circuitry also blocks the memory access transaction, in response to a determination that (a) UPM is enabled and (b) the address for the memory access transaction falls within the UPM region. Other embodiments are described and claimed.

### TECHNICAL FIELD

The present disclosure pertains in general to data processing systems and in particular to technology for managing system software.

### BACKGROUND

A data center includes server computers (“servers”) which provide services to client computers (“clients”). For instance, a cloud service provider (CSP) may operate a data center containing hundreds of servers that provide services to thousands of clients. Each server may include both hardware and software components.

The hardware components may include random access memory (RAM) and at least one processor that accesses the RAM via a memory management unit (MMU). The server may also include peripheral devices that access the RAM with assistance from an input/output memory management unit (IOMMU). In particular, the IOMMU may enable the devices to use direct memory access (DMA) to access the RAM independently from the processor. For instance, the IOMMU may use one or more page tables to translate virtual addresses from DMA requests into corresponding physical addresses for accessing RAM. Such page tables may be referred to as “DMA tables” (DMATs). Also, a virtual address from a DMA request may also be referred to as a “DMA address,” and the process of translating a DMA address to a physical address may be referred to as “DMA address translation.”

The software components may include system software (SS), such as a virtual machine monitor (VMM) that enables the server to create and manage guest virtual machines (VMs) for clients. In addition or alternatively, the SS may include a host OS which runs underneath or on top of a VMM. One aspect of SS operation may be for the SS to set up control structures for translating DMA addresses. Such control structures may be referred to as “DMA address translation structures,” and they may include, for instance, one or more DMATs.

A data center operator may try to achieve a very high degree of server availability. For instance, the operator may try to deliver “five nines availability.” For a server to achieve five nines availability, the server must be capable of providing services to clients 99.999% of the time. Consequently, downtime must not exceed 5.26 minutes per year, 26.3 seconds per month, etc. Nevertheless, the operator may occasionally want to update the SS in a server, to replace the “old” version of the SS (i.e., the version that is currently running on the server) with a new version. However, the process for updating the SS may adversely affect server availability, because the server may be unable to provide services to clients during at least part of the update process.

### BRIEF DESCRIPTION OF THE DRAWINGS

Features and advantages of the present invention will become apparent from the appended claims, the following detailed description of one or more example embodiments, and the corresponding figures, in which:

FIGS. 1A and 1B are block diagrams of an example embodiment of a hypothetical data processing system that includes technology for transferring IOMMU ownership to a new version of SS efficiently and securely.

FIG. 2 presents a flowchart of an example embodiment of a process for transferring IOMMU ownership to a new version of SS.

FIG. 3 presents a flowchart of an example embodiment of an alternative process for transferring IOMMU ownership to a new version of SS.

FIGS. 4A and 4B present a flowchart of an example embodiment of a process for handling memory access transactions.

FIG. 5 is a block diagram of the data processing system of FIG. 1A illustrating additional features for transferring IOMMU ownership.

FIG. 6 is a block diagram of an example embodiment of a hypothetical data processing system that uses multiple range registers to identify protected memory regions.

FIG. 7 is a block diagram of an example embodiment of a hypothetical data processing system that uses a flat protection table to identify protected memory regions.

FIG. 8 is a block diagram of an example embodiment of a hypothetical data processing system that uses a tree of protection tables to identify protected memory regions.

FIG. 9 is a block diagram of a system according to one or more embodiments.

FIG. 10 is a block diagram of a first more specific exemplary system according to one or more embodiments.

FIG. 11 is a block diagram of a second more specific exemplary system according to one or more embodiments.

FIG. 12 is a block diagram of a system on a chip according to one or more embodiments.

### DETAILED DESCRIPTION

As indicated above, the process of updating the SS in a conventional server may adversely affect server availability, because the server may be unable to provide services to clients during at least part of the update process. For instance, the update process may include the following steps: (a) terminate all guest VMs; (b) reset all devices, to guarantee that all outstanding DMA requests are complete; (c) disable IOMMU-based protection of memory that contains DMA address translation structures; (d) launch the new version of the SS; (e) use the new version of the SS to reconfigure the DMA address translation structures or to create new address translation structures (such as page tables); (f) configure the IOMMU to use the new address translation structures, if necessary; (g) re-enable IOMMU-based protection of memory that contains DMA address translation structures; and (h) restart the guest VMs. Consequently, a significant amount of time may pass between the time the guest VMs are terminated and the time they are restarted. During that time, the server is effectively unavailable to the clients that own those guest VMs.

Also, the IOMMU in a conventional server may support a protected memory region (PMR). A PMR is a region of memory that cannot be access by devices using DMA. However, in a conventional server, the IOMMU is always able access the PMR. For instance, when the IOMMU receives an address translation request, the IOMMU may respond by accessing a page table in the PMR.

According to the present disclosure, however, system software may establish a region of memory that cannot be access by devices using DMA, and that also cannot be accessed by the IOMMU in certain circumstances. For purposes of this disclosure, such a region may be referred to as an “ultra-protected memory region” (UPMR). In particular, as described in greater detail below, in one embodiment, the IOMMU can only access the UPMR if a particular register in the IOMMU points to the UPMR.

In one embodiment, a data processing system uses a UMPR to efficiently and securely transfer ownership of the IOMMU from an old version of the SS to a new version of the SS. This technology may enable a server to achieve greater availability, relative to a conventional server. For purposes of this disclosure, SS may be described as “owning” an IOMMU if the SS controls how the IOMMU operates. For instance, the SS that owns the IOMMU is the SS that controls the DMA address translation structures used by the IOMMU. Those structures may include, for instance, a root table address (RTA) register in the IOMMU, corresponding DMATs, etc. DMA address translation structures are one general type of SS control structure. The IOMMU may also use other SS control structures, such as interrupt remapping tables (IRTs), IOMMU command queues (ICQs), etc. An ICQ is a queue in memory that is used to pass information between the SS and the IOMMU hardware. For instance, the ICQs in a data processing system may include an input queue (IQ) to contain information to be input into the IOMMU from the SS, and an output queue (OQ) to contain information that is output by the IOMMU to the SS. An OQ may also be referred to as a “page request queue” (PRQ). In one embodiment, such queues are implemented as circular queues in RAM with head and tail pointers. For purposes of this disclosure, the control structures used by the IOMMU may be referred to in general as “DMA control structures.” Transferring ownership of an IOMMU from an old SS to a new SS involves allowing the new SS to modify the DMA control structures and/or to create new DMA control structures.

A transfer according to the present disclosure is referred to as “efficient” at least in part because the server completes the transfer process while spending less time effectively unavailable to clients, relative to conventional systems. And a transfer according to the present disclosure is referred to as “secure” at least in part because the new SS establishes DMA control structures in a region of memory that is inaccessible to memory access transactions associated with the old SS. For purposes of this disclosure, memory that is inaccessible to memory access transactions associated with the old SS may be referred to as “ultra-protected memory” (UPM). As described in greater detail below, a data processing system according to the present disclosure includes transaction security circuitry (TSC) which enables the new SS to create UPM.

In one scenario, the new SS has created a new DMAT. However, before the new SS was launched, the old SS had allocated a virtual address to a device, and the old SS had created an old DMAT which included a page table entry which translated that virtual address to a physical address that now resides within a new DMAT. Nevertheless, the TSC in the data processing system prevents the device from using that virtual address to access the new DMAT. If an IOMMU transaction involving that virtual address starts before the new SS sets the RTA register to point to the new DMAT, the IOMMU will assign a personality of “old” to that transaction. Consequently, the TSC will not allow that transaction to access the new DMAT while UPM is enabled, because the new DMAT resides in UPM. Also, the TSC will not allow any DMA transactions to access UPM while UPM is enabled. And the new SS will not disable UPM until all old transactions have been drained.

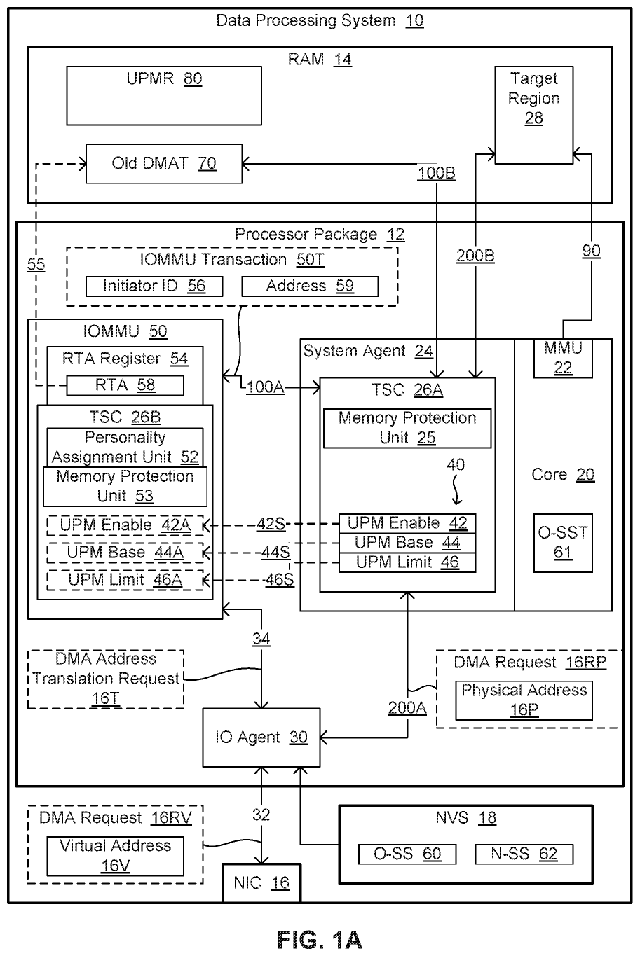

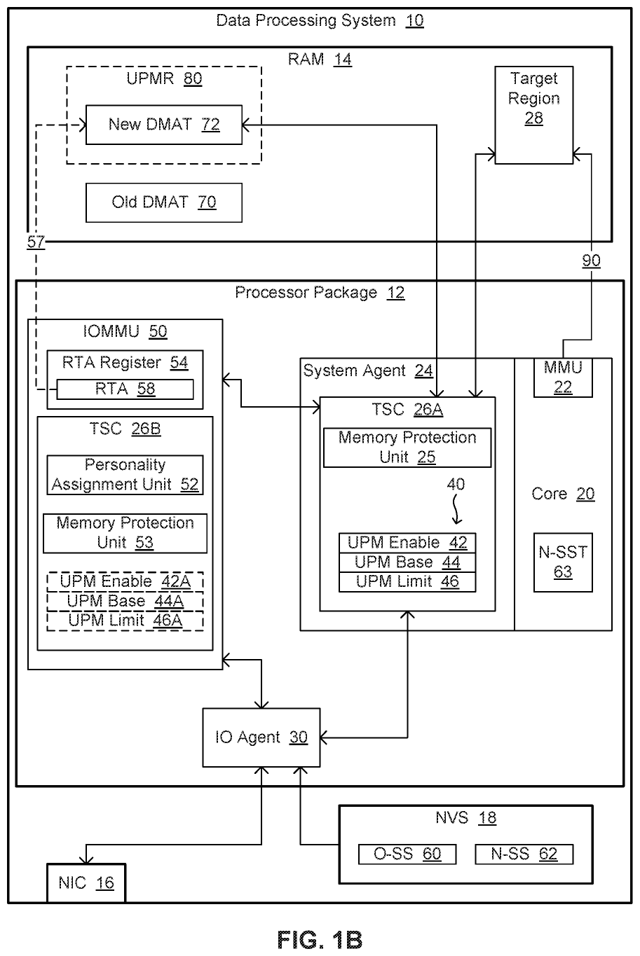

FIGS. 1A and 1B are block diagrams of an example embodiment of a hypothetical data processing system 10 that includes technology for transferring IOMMU ownership to a new version of SS efficiently and securely. This disclosure describes data processing system 10 in connection with one or more hypothetical scenarios to illustrate the technology within data processing system 10 for transferring IOMMU ownership efficiently and securely. In one scenario, data processing system 10 is part of a data center. In particular, data processing system 10 is being used as a server that provides services to clients. As described in greater detail below, in an example scenario, a system administrator of data processing system 10 updates the SS running on data processing system 10. FIG. 1A focuses on the configuration that exists in data processing system 10 in the initial parts of the update process, and FIG. 1B focuses on the configuration that exists in data processing system 10 after completion of the update process.

The hardware in data processing system 10 includes a processor package 12 and various other components coupled to, or in communication with, processor package 12. Those components include RAM 14, a network interface controller (NIC) 16, and non-volatile storage (NVS) 18. NIC 16 and NVS 18 are peripheral devices which use DMA to access RAM 14. For purposes of this disclosure, a peripheral device may be referred to simply as a “device.”

In other embodiments, a data processing system may include many other components coupled to the processor. Also, a data processing system may include multiple processors. A processor may be implemented as an integrated circuit or “chip” that is mounted to a substrate to form a processor package. Alternatively, a processor may be implemented as a package that contains more than one chip. Similarly, each of the other components may be implemented using a package that contains one or more chips. Alternatively, in some embodiments, two or more components may reside on the same package. For instance, a processor package may include a system agent and one or more processing cores, and that package may also include an IOMMU and/or an IO agent. Furthermore, in some embodiments, the system agent may include the IOMMU and/or the IO agent. In addition or alternatively, the IO agent may include the IOMMU.

NVS 18 includes software that can be copied into RAM 14 and executed by processor package 12. In the example of FIG. 1A, that software includes two different versions of SS: an old version (“O-SS”) 60 and a new version (“N-SS”) 62. As indicated above, the SS may be software for implementing a VMM. A VMM may also be referred to as a “hypervisor.” In one embodiment, that VMM is designed to run without an underlying host OS. Accordingly, that VMM may be referred to as a “type-1 hypervisor” or a “bare metal hypervisor.” However, a type-1 hypervisor may be designed to run a host OS or “root OS” on top of the hypervisor (e.g., in a root partition), with that host OS to support VMs or “child partitions” for executing guest OSs. Other embodiments may use a VMM that runs on top of a host OS. In other words, other embodiments may use a so-called “hosted hypervisor” or “type-2 hypervisor.” For purposes of this disclosure, the terms “system software” and “SS” may be used in general to refer to bare metal hypervisors, to hosted hypervisors, to host OSs, and to any other type of software that is designed to perform tasks such as managing DMA control structures.

In the example of FIG. 1A, processor package 12 includes a processing core 20, a system agent 24, an input/output (IO) agent 30, and an IOMMU 50. However, in other embodiments, one or more components (e.g., an IO agent and/or an IOMMU) may reside in a package that is separate from the package with the processing core. In one embodiment, system agent 24 may be implemented as an uncore, for example. For purposes of this disclosure, a processor package may be referred to simply as a “processor,” and a processing core may be referred to simply as a “core.” Core 20 includes execution units such as one or more arithmetic logic units (ALUs), one or more floating-point units (FPUs), etc. As illustrated, core 20 also includes an MMU 22 for translating virtual addresses to physical addresses. In other embodiments, a processor may include multiple cores. Also, a core may support simultaneous multithreading (SMT) by providing two or more logical processors (LP) for executing two or more respective threads simultaneously. A core which supports SMT may also be referred to as a “multi-threaded core.” For purposes of this disclosure, the term “thread processing unit” (TPU) may be used to refer to a single-threaded core and to an LP in a multi-threaded core. In other words, single-threaded cores and LPs may be referred to more generally as TPUs.

In one embodiment, the operations performed by IO agent 30 include buffering DMA requests from devices, and the operations performed by IOMMU 32 include translating virtual addresses from DMA requests into physical addresses. Also, as described in greater detail below, IOMMU 50 includes technology for enabling a new version of SS (e.g., N-SS 62) to take ownership of IOMMU 50.

System agent 24 includes various logic blocks or circuits other than execution units. For instance, system agent 24 may include a memory controller for accessing RAM 14 in response to signals from components such as MMU 22, IO agent 30, and IOMMU 50. However, FIG. 1A does not show a memory controller, to enable other components to be more easily shown and understood. Also, in the example of FIG. 1A, system agent 24 includes TSC 26A, and IOMMU 50 includes TSC 26B. TSC 26A and TSC 26B include at least some of the technology for enabling a new version of SS to take ownership of IOMMU 50.

IOMMU 50 uses DMA address translation structures to perform DMA address translation (i.e., to translate virtual addresses from DMA requests into corresponding physical addresses for accessing RAM 14). In one embodiment, data processing system 10 provides DMA address translation structures like those described in the June 2019 version of the “Intel® Virtualization Technology for Directed I/O Architecture Specification” (the “VT-d Specification”). Accordingly, the DMA address translation structures include at least DMAT.

Also, a data processing system may use multiple levels of DMATs to perform DMA address translation, including a root DMAT and one or more additional DMATs. For instance, in a two-level page table structure, the DMATs may include (a) a root DMAT that is configured as page-directory table, containing page directory entries, each of which points to a page table, and (b) multiple page tables, each of which includes page table entries. Alternatively, in a three-level page table structure, the DMATs may include (a) a root DMAT that is configured as a page-directory-pointer table, containing directory-pointer entries, each of which points to a page-directory table, (b) multiple page-directory tables containing page-directory entries, each of which points to a page table, and (c) multiple page tables, each of which includes page table entries. Alternatively, the page table structure may support scalable mode address translation, with a root DMAT implemented as a scalable-mode root table, and other levels of DMATs including context tables, process address-space identifier (PASID) directories, PASID tables, first-level page table structures, and/or second-level page table structures. For purposes of this disclosure, for multi-level directory structures or trees, the root level may be referred to as the “top-level,” and the other level(s) may be referred to as “lower level(s).”

The DMA address translation structures also include an RTA register 54 in IOMMU 50. RTA register 54 contains a pointer to the base of the root DMAT.

For ease of understanding, FIG. 1A only shows one DMAT in RAM 14. The illustrated DMAT is the root DMAT that is used by O-SS 60 for DMA address translation. Accordingly, that DMAT may be referred to as the “old DMAT” 70. Also, RTA register 54 includes a pointer to old DMAT 70. That pointer may be referred to as the RTA 58. In FIG. 1A, dashed arrow 55 shows that RTA 58 is the address of old DMAT 70.

One aspect of SS operation is for the SS to set up the DMA control structures such as RTA register 54 and the DMATs before activating DMA address translation.

As described in greater detail below, in an example scenario, a system administrator of data processing system 10 updates the SS in data processing system 10 from O-SS 60 to N-SS 62. However, before the update, O-SS 60 is running on processor 12, with DMA address translation activated. For instance, O-SS 60 may be managing a VM that is running in data processing system 10 with access to a particular region of memory that O-SS 60 has allocated to that VM. In FIG. 1A, that region is depicted as target region 28.

In the example of FIG. 1A, O-SS 60 has also configured NIC 16 to enable NIC 16 to access target region 28 via DMA. For instance, O-SS 60 has provided NIC 16 with a virtual address 16V to be used to access target region 28 via DMA. Accordingly, old DMAT 70 includes at least one entry to translate virtual address 16V to a physical address within target region 28. Consequently, when DMA address translation is enabled, NIC 16 may use that DMA address to access target region 28. For instance, NIC 16 may receive data from a network, and NIC 16 may use DMA to load that data into target region 28.

As indicated above, system agent 24 includes TSC 26A, and IOMMU 50 includes TSC 26B. TSC 26A and TSC 26B enable N-SS 62 to establish a region of memory in RAM 14 that cannot be accessed by memory access transactions associated with O-SS 60. For purposes of this disclosure, that region may be referred to as an “ultra-protected memory region” (UPMR).

As described in greater detail below, during the process for updating from O-SS 60 to N-SS 62, O-SS 60 configures UPM registers 40 in TSC 26A with values to define the UPMR. For instance, in one embodiment, UPM registers 40 include a UPM enable register 42, a UPM base register 44, and a UPM limit register 46. The value in UPM base register 44 specifies the start of the UPMR. The value in UPM limit register 46 specifies the size of the UPMR. And the value in UPM enable register 42 indicates whether or not protection of UPM is active. As described in greater detail below, O-SS 60 may update the UPM registers to establish a UPMR. Such a region is illustrated in FIG. 1A as UPMR 80. When defining UPMR 80, O-SS 60 selects an address space that does not contain any current DMATs (such as old DMAT 70).

TSC 26B in IOMMU 50 also includes a set of UPM registers (e.g., a UPM enable register 42A, a UPM base register 44A, and a UPM limit register 46A). As indicated by dashed arrows 42S, 44S, and 46S, when O-SS 60 updates UPM registers 40, system agent 24 automatically copies those values to the corresponding registers in IOMMU 50. As described in greater detail below, when UPM enable register 41 is set, IOMMU 50 and system agent 24 may then protect UPMR 80 (e.g., by preventing any IOMMU transactions involving old DMAT 70 from accessing UPMR 80).

As indicated above, devices such as NIC 16 may use DMA to load data into target region 28. In particular, the process for NIC 16 to access target region 28 may involve multiple transactions. FIG. 1A illustrates four of those transactions, starting with a DMA request 16RV (involving a virtual address), which leads to a DMA address translation request 16T, which leads to an IOMMU transaction 50T, which leads finally to a DMA request 16RP (involving a physical address). For purposes of this disclosure, requests such as DMA request 16RV, DMA address translation request 16T, and DMA request 16RP may be referred to in general as “DMA transactions.” Also, DMA transactions and IOMMU transactions may be referred to in general as “memory access transactions.”

Specifically, FIG. 1A illustrates an example scenario in which data processing system 10 is still running O-SS 60. For instance, core 20 may be running at least one O-SS thread (O-SST) 61. Accordingly, the value in RTA register 54 (i.e., RTA 58) is the address of old DMAT 70, as indicated above. Also, NIC 16 has received from O-SS 60 virtual address 16V to be used for DMA.

Arrow 32 shows NIC 16 sending DMA request 16RV to IO agent 30. As illustrated, DMA request 16RV includes virtual address 16V. In the example scenario, NIC 16 is attempting to write data to virtual address 16V. In response to receiving DMA request 16RV, IO agent 30 generates DMA address translation request 16T, based on virtual address 16V, to determine the physical address that corresponds to virtual address 16V. As shown on arrow 34, IO agent 30 sends DMA address translation request 16T to IOMMU 50. In response to receiving DMA address translation request 16T, IOMMU 50 generates IOMMU transaction 50T, which includes an IOMMU transaction address 59 that IOMMU 50 generated based on virtual address 16V and RTA register 54, which contains RTA 58.

Furthermore, when IOMMU 50 generates an IOMMU transaction, IOMMU includes an initiator identifier (ID) in that transaction, to indicate whether the transaction was generated based on (a) DMATs from old SS or (b) DMATs from new SS, as described in greater detail below. The initiator ID may also be referred to as a “personality.” In the example of FIG. 1A, that personality is generated by a personality assignment unit 52 in TSC 26B in IOMMU 50. Accordingly, in the example scenario, IOMMU transaction 50T includes a personality 56 to indicate that the transaction was generated based on DMATs from old SS. Any suitable values may be used in the initiator ID to distinguish between transactions based on DMATs from old SS and transaction based on DMATs from new SS. For instance, a value of 0 or “old” may denote the former, and a value of 1 or “new” may denote the latter.

As shown by arrows 100A and 100B, IOMMU 50 uses IOMMU transaction 50T to access old DMAT 70, to retrieve the physical address that corresponds to virtual address 16V. In particular, as shown by arrow 100A, IOMMU 50 sends IOMMU transaction 50T to system agent 24. And in response, system agent 24 uses IOMMU transaction address 59 to access a specific entry in old DMAT 70 which provides the physical address that corresponds to virtual address 16V, as shown by arrow 100B. However, as described in greater detail below, if UPM has been enabled, TSC 26A or TSC 26B can abort or block such transactions. In particular, in the example of FIG. 1A, TSC 26B includes a memory protection unit 53 that abort or blocks “old” IOMMU transactions to protect UPM. And in an alternative embodiment, logic for blocking “old” IOMMU transactions may reside in the TSC (e.g., in another memory protection unit) in the system agent. However, if the transaction is not blocked, IOMMU 50 then returns that physical address to IO agent 30.

IO agent 30 then generates DMA request 16RP, which includes the physical address 16P that corresponds to virtual address 16V, as well as the data to be written to RAM 14. As shown by arrow 200A, IO agent 30 then sends DMA request 16RP to system agent 24. In response, system agent 24 writes the data to physical address 16P, as shown by arrow 200B. However, as described in greater detail below, if UPMR 80 has been enabled, TSC 26A can abort or block such transactions. In particular, in the example of FIG. 1A, TSC 26A includes a memory protection unit 25 that abort or blocks “old” DMA transactions, to protect UPM. Also, as indicated above, in an alternative embodiment, memory protection unit 25 may also include the logic for blocking “old” IOMMU transactions.

As indicated above, in a conventional system, transferring ownership of the IOMMU to new SS may involve steps such as terminating all guest VMs; resetting all devices, to guarantee that all outstanding DMA requests are complete; disabling IOMMU-based protection of memory; launching the new SS; using the new SS to create new address translation structures and to configure the IOMMU to use those new address translation structures; re-enabling IOMMU-based protection of memory; and restarting the guest VMs. However, as described in greater detail below, a data processing system according to the present disclosure may use a different process. In addition, that process may be more efficient that the process used by a conventional system.

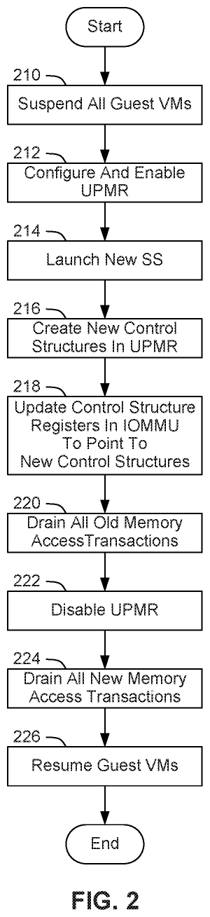

FIG. 2 presents a flowchart of an example embodiment of a process for transferring ownership of IOMMU 50 from O-SS 60 to N-SS 62. The process of FIG. 2 starts with O-SS 60 suspending all guest VMs, as shown at block 210. As shown at block 212, O-SS 60 then configures and enables UPMR 80, by updating UPM registers 40 with the starting address and the size for UPMR 80, and by setting the UPM enable register 42. In particular, O-SS 60 locates UPMR 80 in portion of RAM 14 that does not contain any current DMA translation structures, such as old DMAT 70. In one embodiment, O-SS 60 locates UPMR 80 in a portion of RAM 14 that does not contain any SS control structures.

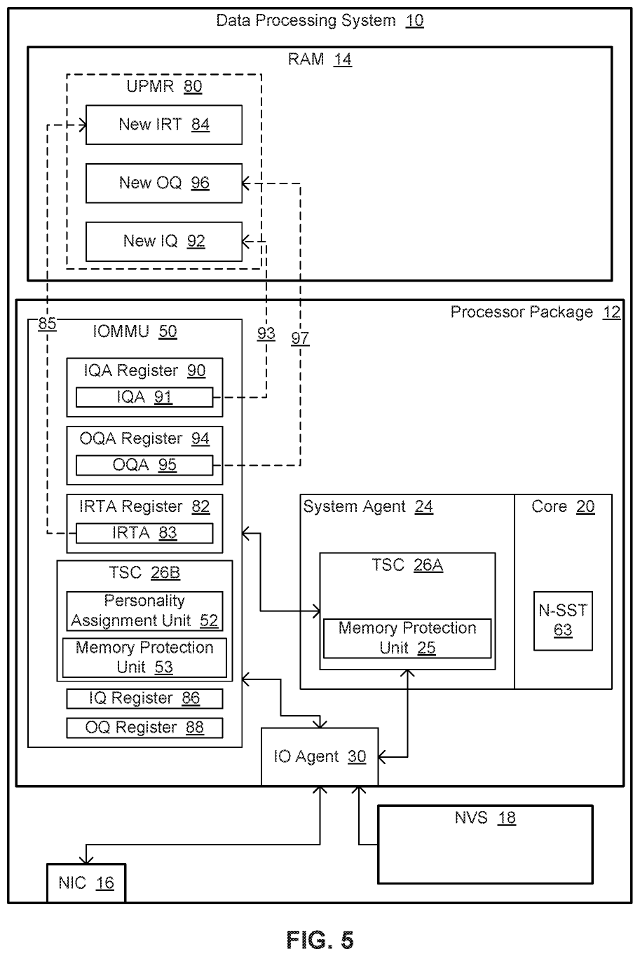

As shown at block 214, O-SS 60 then causes data processing system 10 to launch N-SS 62 and terminate O-SS 60. As shown at block 216, N-SS 62 then creates new versions of various SS control structures in UPMR 80. For instance, those structures may include DMA control structures (e.g., a root DMAT, one or more additional DMATs, IRTs, ICQs, etc.), as well as other SS control structures, such as VM control structure (VMCS) pages. As shown at block 218, N-SS 62 then updates corresponding registers in IOMMU 50 to point to those new control structures. For instance, N-SS 62 may execute an instruction or command which updates RTA register 54 to point to the new root DMAT. Similarly, as described in greater detail below with regard to FIG. 5, IOMMU 50 may include at least one IRT address (IRTA) register to contain the address of the base of an IRT and at least one ICQ address (ICQA) register to contain the address of the base of an ICQ. N-SS 62 may execute instructions or commands which update the IRTA and ICQA registers with new base addresses for new IRTs and ICQs in UPMR 80. For purposes of this disclosure, registers in an IOMMU that point to SS control structures may be referred to in general as “control structure registers.”

As shown at block 220, N-SS 62 then drains any memory access transactions that are still in process to a global observation point. Draining those transactions will ensure that the system does not contain any transactions in process with the personality of “old.” As shown at block 222, N-SS 62 then disables UPM by clearing UPM enable register 42. As shown at block 224, N-SS 62 then drains any memory access transactions that might be in process with the personality of “new.” As shown at block 226, N-SS 62 then resumes the guest VMs, and the transfer of ownership is complete. Data processing system 10 may then run N-SS 62 until it is time for a new system-software update. The above process may then be used to replace N-SS with the new update.

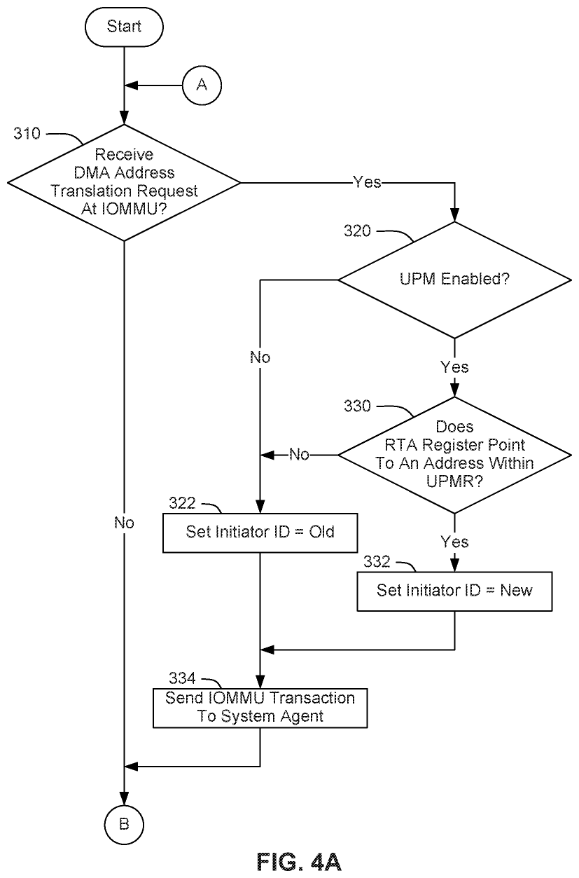

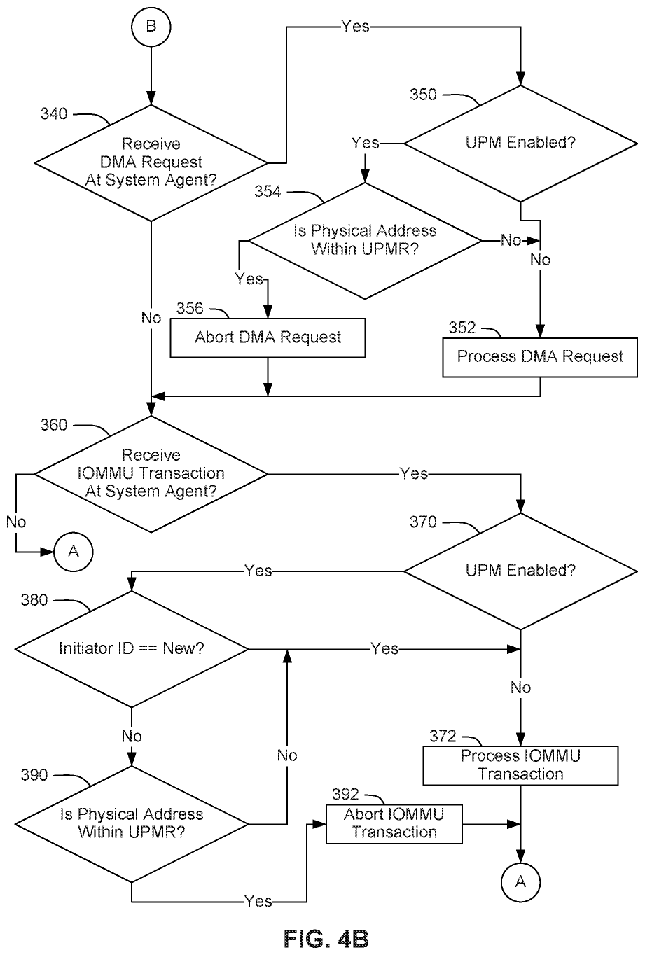

Referring again to blocks 220 and 224, in one embodiment or scenario, N-SS 62 drains any memory access transactions that are still in process by (a) invalidating all DMA translation caches and (b) issuing a command to IOMMU 50 to confirm that all invalidations have been completed. Once that confirmation is received, there is no longer a risk of a memory access transaction (e.g., a DMA transaction or an IOMMU transaction) being in process with an address from old DMAT 70 (or any old DMATs). As indicated above, N-SS 62 then disables UPM. Memory protection unit 25 in TSC 26A and memory protection unit 52 in TSC 26B may then allow memory access transactions to access the region that was protected as UPMR 80, without regard to the personalities for those transactions. Also, as described in greater detail below with regard to FIG. 4A, personality assignment unit 52 in TSC 26B may assign the personality of “old” to all subsequent pagewalks initiated while UPM is disabled.

A data processing system may thus transition DMATs, IRTs, ICQs, and such from old SS to new SS as part of the process for updating the SS.

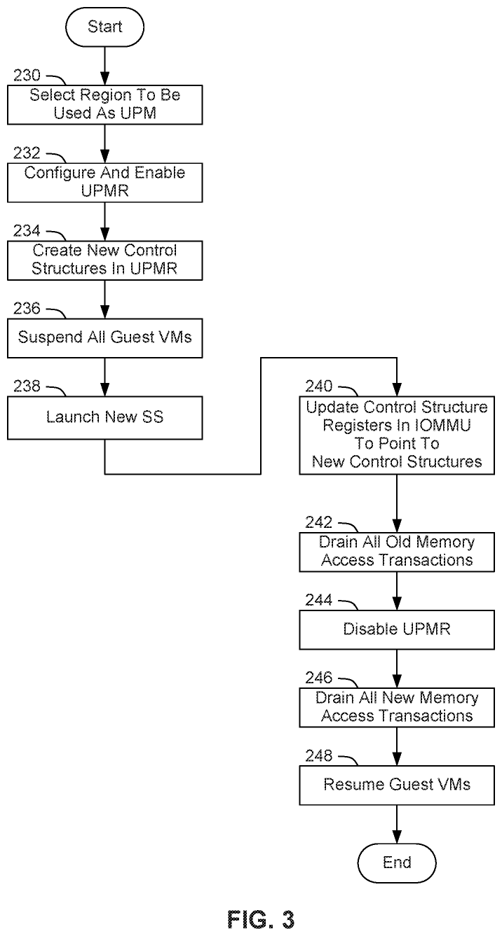

FIG. 3 presents a flowchart of an example embodiment of an alternative process for transferring IOMMU ownership to a new version of SS. The process of FIG. 3 starts with O-SS 60 identifying a range (or pages) of memory to be used as UPM, as shown at block 230. As indicated above, O-SS 60 selects a range that does not contain any current DMA translation structures and/or any SS control structures. As shown at block 232, O-SS 60 then configures and enables UPMR 80, as indicated above with regard to block 212 of FIG. 2. As shown at block 234, O-SS 60 then creates new versions of various SS control structures (e.g., a root DMAT, etc.) in UPMR 80, as indicated above with regard to block 216 and N-SS 62. For instance, in one embodiment, O-SS 60 loads and launches N-SS 62 in a secure and virtualized environment (e.g., as a secure VM or a trustlet), N-SS 62 then creates various SS control structures in memory, and then that environment closes. Thus, O-SS 60 may create new versions of the control structures to be used by N-SS 62 without terminating the guest VMs that are running for clients under O-SS 60 in data processing system 10.

As shown at block 236, O-SS 60 then suspends all guest VMs. As shown at block 238, O-SS 60 then launches N-SS 62 and terminates O-SS 60. When N-SS 62 is launched, it securely discovers the previously created control structures and allocates any remaining control structures as needed. As shown at block 240, N-SS 62 then updates control structure registers in IOMMU 50 to point to those new control structures. As shown at block 242, N-SS 62 then drains any old memory access transactions that are still in process to a global observation point. As shown at block 244, N-SS 62 then disables UPM by clearing UPM enable register 42. As shown at block 246, N-SS 62 then drains any memory access transactions that might be in process with the personality of “new.” As shown at block 248, N-SS 62 then resumes the guest VMs, and the transfer of ownership is complete. Thus, the process of FIG. 3 enables the guest VMs to be paused for less time than the process of FIG. 2, with all of the cost or overhead of setting up new DMATs and other control structures being abosorbed while the guest VMs are still running. The process of FIG. 3 may thus enable the new SS to be installed with less impact to tenants.

FIG. 1B depicts data processing system 10 after the transfer of ownership of IOMMU 50 from O-SS 60 to N-SS 62 has finished. Accordingly, FIG. 1B shows at least one N-SS thread (N-SST) 63 running on core 20. Also, even though FIG. 1B illustrates a scenario in which UPM is no longer enabled, FIG. 1B shows UPMR 80 with dashed lines, to denote the region that was protected earlier, when UPM was enabled, and FIG. 1B shows new DMAT 72 within that region. In one embodiment, new DMAT 72 is a new root DMAT that was created by N-SS 62 along with additional DMATs, and N-SS 62 created all of those DMATs in UPMR 80. Also, RTA register 54 in IOMMU 50 contains a pointer to new DMAT 72. In FIG. 1B, dashed arrow 57 shows that new RTA 58 is the address of new DMAT 72.

FIGS. 4A and 4B present a flowchart of an example embodiment of a process for handling memory access transactions. That process is described in the context of FIG. 1B. The process of FIG. 4A starts with TSC 26B in IOMMU 50 determining whether IOMMU 50 has received a DMA address translation request from IO agent 30, as shown at block 310. If TSC 26B has received such a request, IOMMU 50 builds an IOMMU transaction, such as IOMMU transaction 50T. As part of that process, personality assignment unit 52 in TSC 26B determines whether UPM has been enabled, as shown at block 320. If UPM has not been enabled, personality assignment unit 52 assigns a personality of “old,” as shown at block 322. If UPM has been enabled, personality assignment unit 52 determines whether RTA 58 (the value in RTA register 54) points to an address within UPMR 80, as shown at block 330. If RTA 58 points to an address within UPMR 80, personality assignment unit 52 sets the personality to “new,” as shown at block 332. Otherwise, personality assignment unit 52 sets the personality to “old,” as shown at block 322. As shown at block 334, IOMMU 50 then sends the IOMMU transaction to system agent 24. The process of FIG. 4A may then pass through page connector B to FIG. 4B.

The process of FIG. 4B starts with memory protection unit 25 in system agent 24 determining whether system agent 24 has received a DMA request from IO agent 30, as shown at block 340. If system agent 24 has received such a DMA request, memory protection unit 25 determines whether UPM is enabled, as shown at block 350. If UPM is not enabled, memory protection unit 25 allows system agent 24 to process the request, as shown at block 352. In particular, system agent 24 accesses RAM 14 according to the request. However, if UPM is enabled, memory protection unit 25 determines whether the physical address for the DMA request falls within the UPMR, as shown at block 354. If the physical address falls within the UPMR, memory protection unit 25 aborts or blocks the request, as shown at block 356. However, if the physical address does not fall within the UPMR, memory protection unit 25 allows system agent 24 to process the request, as shown at block 352. Thus, memory protection unit 25 does not allow any DMA requests from IO agent 30 to access the UPMR if UPM is enabled.

Referring again to block 340, in one embodiment, if system agent 24 has not received a DMA request, memory protection unit 25 determines whether system agent 24 has received an IOMMU transaction, as shown at block 360. If not, the process may return to block 310 of FIG. 4A via page connector A. If system agent 24 has received an IOMMU transaction, memory protection unit 25 determines whether UPM is enabled, as shown at block 370. If UPM is not enabled, system agent 24 processes the transaction, as shown at block 372. In particular, system agent 24 accesses the DMATs in RAM 14, based on the address in the IOMMU transaction, to retrieve the corresponding physical address. However, if UPM is enabled, memory protection unit 25 determines whether the personality in the transaction is “new,” as shown at block 380. That is to say, memory protection unit 25 determines whether the initiator ID indicates that the transaction was generated by IOMMU 50 at a time when RTA register 54 contained a value that fell within the UPMR, which would indicate that the transaction was generated after N-SS 62 had been launched. If the personality is “new,” system agent 24 processes the transaction, as shown at block 372. However, if UPM is enabled, but the personality is not “new,” the process then passes from block 380 to block 390, with memory protection unit 25 then determining whether the physical address for the IOMMU transaction is in a UPMR. If the physical address is in a UPMR, memory protection unit 25 aborts or blocks the transaction, as shown at block 392. Otherwise, as shown at block 372, TSC 26A processes the transaction. The process may then return to block 310 of FIG. 4A via page connector A.

In another embodiment, memory protection unit 25 does not monitor IOMMU transactions, but memory protection unit 52 does. For instance, system agent 24 may return the physical address to IOMMU 50, and then memory protection unit 53 may determine whether (a) UPM is enabled, (b) the IOMMU transaction has a personality of “old,” and (c) the physical address falls within the UPMR, and memory protection unit 25 may block or abort the IOMMU transaction in response to a positive determination.

Thus, when UPM is enabled, no DMA requests are allowed to access UPMR 80, and IOMMU transactions which involve UPMR 80 are allowed only if those transactions were generated after the RTA register was updated (by N-SS 62) to point to a structure within UPMR 80. However, if “old” IOMMU transactions do not touch UPM, they are allowed. For purposes of this disclosure, an IOMMU transaction with a personality of “new” may be referred to as having a personality of “IOMMU-New” or “IOMMU-N,” and an IOMMU transaction with a personality of “old” may be referred to as having a personality of “IOMMU-Old” or “IOMMU-O.” Thus, an IOMMU transaction with a personality of IOMMU-N is a transaction that used an RTA value that fell within the UPMR. Also, all transactions generated while UPM is not enabled may be given a personality of “old” (i.e., a personality of IOMMU-O). When UPM is enabled, transactions with a personality of IOMMU-O are blocked from accessing the UPMR, and transactions with a personality of IOMMU-N are allowed to access the UPMR. When UPM is not enabled, there is no UPMR, and transactions with either personality (IOMMU-O or IOMMU-N) are allowed to access RAM 14.

FIG. 5 is a block diagram of the data processing system of FIG. 1A illustrating additional features for transferring IOMMU ownership. As indicated above with regard to FIG. 2, the process for updating the SS may involve transitioning structures such as IRTs and ICQs the old SS to the new SS. For instance, as indicated above with regard to block 216 of FIG. 2, the process for updating the SS may include creating new versions of the IRTs and the ICQs in UPMR 80. In particular, FIG. 5 depicts an embodiment in which N-SS 62 has updated UPMR 80 in RAM 14 to include at least one new IRT 84, a new input queue (IQ) 92, and a new output queue (OQ) 96. Also, IOMMU 50 includes an IRTA register 82 to contain the address of the base of the current IRT, an IQ address (IQA) register 90 to contain the address of the base of the current IQ, and an OQ address (OQA) register 94 to contain the address of the base of the current OQ. As indicated above with regard to block 218 of FIG. 2, N-SS 62 may update (a) IRTA register 82 to contain the address of the base of a new IRT 84, (b) IQA register 90 to contain the address of the base of new IQ 92, and (c) OQA register 94 to contain the address of the base of new OQ 96. Thus, as shown in FIG. 5, after such updates, IRTA register 82 contains an IRTA 83 which points to the base of new IRT 84, as indicated by arrow 85. Also, IQA register 90 contains an IQA 91, which points to the base of new IQ 92, as indicated by arrow 93, and OQA register 94 contains an OQA 95 which points to the base of new OQ 96, as indicated by arrow 97. Thus, after the new SS is launched, the new SS may update the IQA and OQA registers with new base addresses for the new IQ and the new OQ in UPMR. The IOMMU may also include features which allow the SS to pause processing of the IQ and the OQ, and to take other actions in connection with an SS update, as described in greater detail below.

In addition, IOMMU 50 includes features which allow the SS to pause the processing of the current IQ and the current OQ. When those queues are paused, IOMMU 50 does not change their head pointers or tail pointers. After IOMMU 50 confirms to the SS that the queues are paused, the SS can disable those queues and then relocate them into UPM, to be subsequently re-enabled.

For instance, in the example of FIG. 5, IOMMU 50 includes an IQ register 86 and an OQ register 88. IQ register 86 may include fields such as a command field and a status field. The SS may pause the current IQ by writing a predetermined “pause” value (e.g., one) to the command field. In response, IOMMU 50 will (a) stop fetching new commands, (b) wait for current command to complete, (c) increment the head pointer, and then (d) set the status field to a predetermined “success” value (e.g., zero), to communicate successful completion of the pause command. And IOMMU 50 may use different “error” values in the status field to indicate error conditions. The SS may then disable the IQ by writing a predetermined “disable” value (e.g., two) to the command field. The SS may then (a) relocate the IQ to UPMR 80, (b) enable the relocated IQ (illustrated in FIG. 5 as “new IQ 92”) by setting the command field to a predetermined “enable” value (e.g., three), and then finally (c) unpause new IQ 92 by setting the command field to a predetermined “unpause” value (e.g., four). In another embodiment, resuming a disabled IQ does not require both “enable” and “unpause” operations, but may be accomplished with only one of those operations.

OQ register 88 may also include fields such as a command field and a status field. The SS may pause the current OQ by writing a predetermined “pause” value (e.g., one) to the command field. In response, IOMMU 50 will stop writing new commands to the OQ and will treat the OQ as full. IOMMU 50 may also set the status field to a predetermined “success” value (e.g., zero), to communicate successful completion of the pause command. The SS may then disable the OQ by writing a predetermined “disable” value (e.g., two) to the command field. The SS may then (a) relocate the OQ to UPMR 80B, (b) enable the relocated OQ (illustrated in FIG. 5 as “new OQ 96”) by setting the command field to a predetermined “enable” value (e.g., three), and then finally (c) unpause new OQ 96 by setting the command field to a predetermined “unpause” value (e.g., four). In another embodiment, resuming a disabled OQ does not require both “enable” and “unpause” operations, but may be accomplished with only one of those operations.

In addition, to protect IRTs from old system software, N-SS 62 may use the same approach as is used to protect DMATs, as described above with regard to FIGS. 4A and 4B. For instance, as part of the interrupt remapping process, when IOMMU 50 receives a incoming interrupt, personality assignment unit 52 may use a process like the one described above with regard to FIG. 4A to assign an initiator ID or personality to the corresponding transaction that IOMMU 50 sends to system agent 24. For purposes of this disclosure, the transaction that an IOMMU sends to a system agent in response to receiving an incoming interrupt may be referred to as an “interrupt transaction.” Thus, if UPM is enabled and the incoming interrupt involves an IRT that resides within UPMR 80, personality assignment unit 52 sets the personality for the corresponding interrupt transaction to “new” (thereby assigning a personality of IOMMU-N). Otherwise, personality assignment unit 52 sets the personality for that interrupt transaction to “old” (thereby assigning a personality of IOMMU-O).

In other embodiments, a data processing system supports multiple UPMRs. Such data processing systems may include basically the same kinds of components as data processing system 10, including at least one processor with a system agent and at least one core, RAM, an IOMMU, TSC in the system agent, TSC in the IOMMU, etc. However, different embodiments may use different techniques, different components in the TSCs, and similar differences to support multiple UPMRs in different ways.

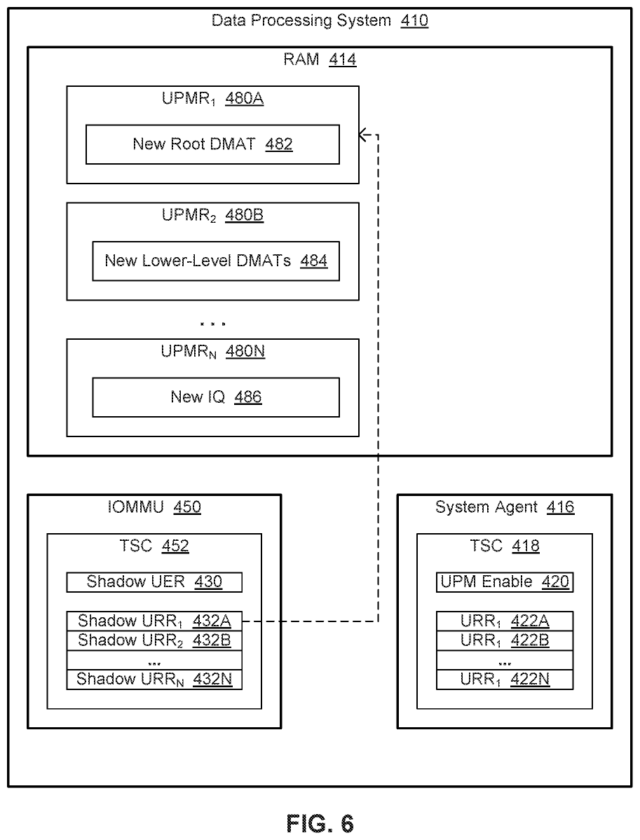

FIG. 6 is a block diagram of an example embodiment of a hypothetical data processing system 410 that uses multiple range registers to identify multiple respective UPMRs. As indicated above, such an embodiment may include the same kinds of components as data processing system 10, including at least one processor with a system agent 416 and at least one core, RAM 414, an IOMMU 450, etc. However, for clarity, some components are not depicted in FIGS. 6-8. Nevertheless, in the example of FIG. 6, system agent 416 includes TSC 418 which includes a UPM enable register 420, along with a set of N UPM range registers (URRs) for defining up to N UPMRs. FIG. 6 depicts such URRs as URR₁ 422A, URR₂ 422B, . . . URR_{N} 422N. However, a URR may be implemented using a UPM base register and a UPM limit register, as described above. Also, the TSC 452 in IOMMU 450 may include the same kinds of UPM registers, which may be referred to as shadow registers, and system agent 416 may automatically copy the data from the UPM registers in system agent 416 to the shadow registers whenever the UPM registers in system agent 416 are updated. FIG. 6 depicts the shadow registers as shadow UPM enable register (UER) 430, shadow URR₁ 432A, shadow URR₂ 432B, . . . , shadow URR_{N} 432N.

The old SS may use one or more of the URRs to specify one or more UMPRs in RAM. And after the old SS launches the new SS, the new SS may use one or more of the remaining URRs (if any) to specify one or more additional UPMRs. FIG. 6 depicts the UMPRs that have been specified using the URRs as UPMR₁ 480A, UPMR₂ 480B, . . . , UPMR_{N}480N. Thus, as indicated be the dashed arrow from shadow URR₁ 432A to UPMR₁ 480A, the values in shadow URR₁ 432A specify the location of UPMR₁ 480A, and the other URRs specify the location of any other UPMRs.

In addition, the new SS may allocate a new root DMAT 482, new lower-level DMATs 484 (i.e., DMA tables at levels lower than the root DMA table), a new IQ 486, and other control structures within any of the UPMRs. The new SS may also update an RTA register in TSC 452 with the RTA for the new root DMAT.

Also, when generating IOMMU transactions, the personality assignment unit in TSC 452 in IOMMU 450 may assign (a) a personality of “new” whenever UPM is enabled and the RTA register points to an address within any of the UPMRs and (b) a personality of “old” (i) whenever UPM is enabled and the RTA register points to an address that does not fall in any of the UPMRs and (ii) whenever UPM is not enabled.

Also, whenever UPM is enabled, a memory protection unit (in TSC 418 in system agent 416 or in TSC 452 in IOMMU 450) may abort or block any IOMMU transaction that has a personality of “old” and an address that falls within any UPMR. And, whenever UPM is enabled, the memory protection unit in TSC 418 may abort or block any DMA request that has an address that falls within any UPMR.

Also, the TSCs may use the same kind of an approach to process interrupts, for instance assigning a personality of “new” whenever the TSC in IOMMU 450 receives an interrupt when (a) UPM is enabled and (b) an IRTA in the TSC resides in any of the UPMRs.

Furthermore, other embodiments may support a greater number of UPMRs by providing for a primary UPMR that is specified using a range register as indicated above, and providing for a secondary UPM catalog to be stored in the primary UPMR, with the secondary UPM catalog describing or defining one or more secondary UPMRs.

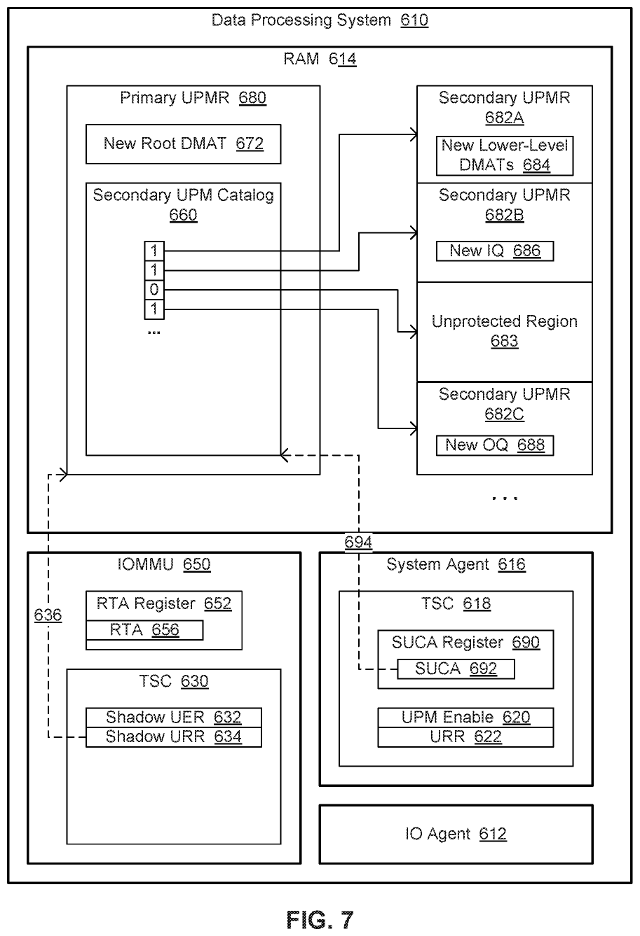

FIG. 7 is a block diagram of an example embodiment of a hypothetical data processing system 610 that uses a flat protection table to identify UPMRs. In other words, the secondary UPM catalog in data processing system 610 is implemented as a flat table or array. Data processing system 610 may include features like those described earlier, such as RAM 614, a processor with at least one core and a system agent 616, an IO agent 612, an IOMMU 650, etc.

Before launching the new SS in data processing system 610, the old SS updates a URR 622 in system agent 616 to specify the location for a primary UPMR 680 and then sets a UPM enable register 620 to activate UPM. System agent 616 automatically copies the values from the UPM registers in TSC 618 to corresponding shadow registers in TSC 630 (e.g., shadow UER 632 and shadow URR 634). As indicated by dashed arrow 636, shadow URR 634 (and URR 622) specifies the location of primary UPMR 680.

When the new SS is launched, it creates a new root DMAT 672 in primary UPMR 680. The new SS also creates a secondary UPM catalog 660 in primary UPMR 680. Secondary UPM catalog 660 specifies the locations of one or more secondary UPMRs. In the example of FIG. 7, secondary UPM catalog 660 is implemented as a flat table which is indexed by host physical address (HPA), with each bit in secondary UPM catalog 660 corresponds to a respective page of physical memory. Accordingly, the bits in secondary UPM catalog 660 may be referred to in general as “protection information” or more specifically as “protection bits.”

In one embodiment, the page size is 4096 bytes or 4 kilobytes (K). In other embodiments, larger or smaller page sizes may be used. The new SS sets bits in secondary UPM catalog 660 (e.g., the first, second, and fourth bits) to specify pages to be protected as UPMRs (e.g., secondary UPMRs 682A, 682B, and 682C, respectively). The new SS also clears bits (e.g., the third bit in secondary UPM catalog 660) to indicate respective pages that are not protected (e.g., unprotected region 683).

The new SS also updates a secondary UPM catalog address (SUCA) register 690 in TSC 618 with the SUCA 692. Thus, as indicated by dashed arrow 694, SUCA 692 specifies the location of secondary UPM catalog 660.

The new SS may also create other control structures within primary UPMR 680 or within the secondary UPMRs. Those other control structures may include, for instance, DMA control structures such as new non-root translation tables and page tables (e.g., new lower-level DMATs 684), a new IQ 686, a new OQ 688, posted-interrupt descriptor pages, etc., as well as other SS control structures such as VMCS pages.

Also, when generating an IOMMU transaction, a personality assignment unit in TSC 630 in IOMMU 650 may assign (a) a personality of “new” whenever UPM is enabled and the RTA 656 in RTA register 652 falls within primary UPMR 680 and (b) a personality of “old” (i) whenever UPM is not enabled and (ii) whenever UPM is enabled and RTA register 652 points to an address outside of primary UPMR 680.

Also, in one embodiment, when UPM is enabled, a memory protection unit in TSC 618 in system agent 616 may abort or block IOMMU transactions that have a personality of “old” and an address that falls within any UPMR. For instance, if UPM is enabled and the personality is “old,” the memory protection unit uses URR 622, SUCA 692, and secondary UPM catalog 660 to determine whether the address falls within any UPMR. If the protection bit for the address is 0x0 then access is allowed, but if the protection bit is 0x1 then the transaction is aborted or blocked.

In another embodiment, when UPM is enabled and the personality is “old,” a memory protection unit in TSC 630 in IOMMU 650 uses shadow URR 634 to determine whether the address falls in the primary UPMR. Also, TSC 630 includes a shadow copy of SUCA register 690, and if the address does not fall in the primary UPMR, TSC 630 uses that shadow SUCA register to consult secondary UPM catalog 660 to determine whether or not the address falls within any of the secondary UPMRs. If the protection bit for the address is 0x0 then access is allowed. In addition, TSC 630 may change the personality for the transaction from “old” to “new” in response to determining that the address does not fall within any UPMR. However, if the protection bit for the address is 0x1 then the transaction is aborted or blocked. IOMMU 650 may also generate an interrupt to notify the system software about the blocked/faulted transaction.

However, in both of the above embodiments, if the personality is “new” then the transaction is allowed to go through. Also, when UPM is enabled, a memory protection unit in TSC 618 in system agent 616 may abort or block all DMA transactions with an address that falls within any UPMR.

Also, when processing interrupts while UPM is enabled, the personality assignment unit TSC 630 may assign a personality of “new” whenever an interrupt involves an IRTA that falls within any of the UPMRs. For instance, the personality assignment unit may use the shadow SUCA register to consult secondary UPM catalog 660 to determine whether the IRTA falls within any UPMR.

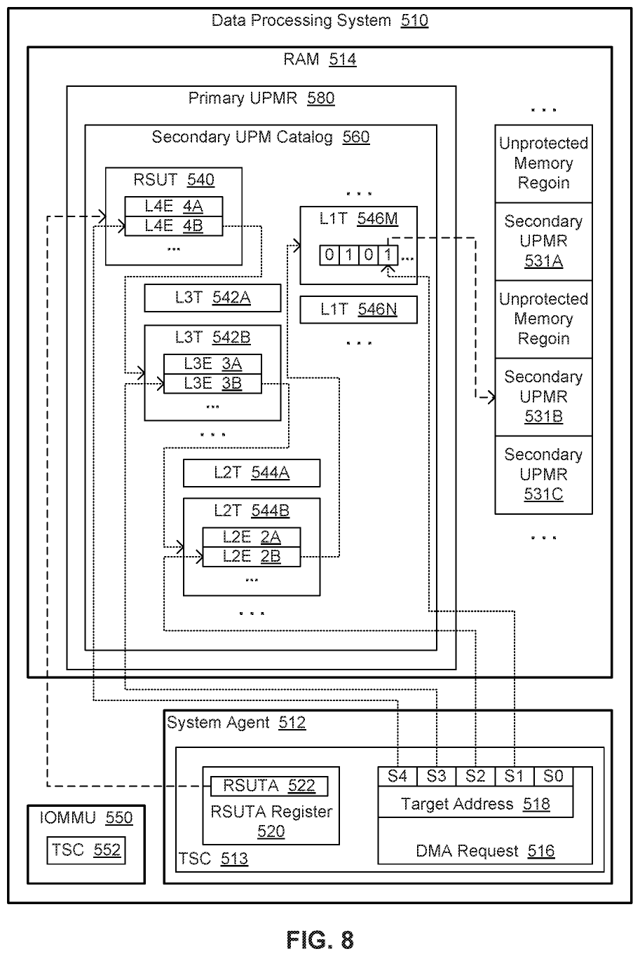

FIG. 8 is a block diagram of an example embodiment of a hypothetical data processing system 510 that uses a tree of protection tables to identify protected memory regions. In other words, the secondary UPM catalog 560 in data processing system 510 is implemented as a tree which includes a hierarchical set of tables. In particular, as described in greater detail below, the tables are linked hierarchically.

As with the other embodiments, data processing system 510 may include features like those described earlier, such as RAM 514, a processor with at least one core and a system agent 512, an IOMMU 550, an IO agent, various registers, etc. However, many of those components are not shown in FIG. 8, to focus on other features. Also, as before launching the new SS in data processing system 510, the old SS updates a URR in the TSC 513 of system agent 512 to specify the location for a primary UPMR 580 and then sets a UPM enable register to activate UPM. System agent 512 automatically copies the values from the UPM registers in system agent 512 to corresponding shadow registers in the TSC 552 in IOMMU 550.

However, in another embodiment, the roles are reversed, in that primary copies of registers such as the UPM enable register and the URR reside in the IOMMU, and the corresponding shadow registers reside in the system agent.

Referring again to the embodiment of FIG. 8, when the new SS is launched, it creates a new root DMAT in primary UPMR 580. The new SS also creates secondary UPM catalog 560 in primary UPMR 580. Secondary UPM catalog 560 specifies the locations of one or more secondary UPMRs. However, in the example of FIG. 8, secondary UPM catalog 560 is implemented as a tree of tables. That tree of tables constitutes a directory structure that is indexed by HPA. In the example of FIG. 8, that directory structure has four levels.

At level 4 (i.e., the highest level) is a root supplemental UPM table (RSUT) 540 that contains at least one level-4 entry (L4E), such as L4E 4A, L4E 4B, etc. RSUT 540 may also be referred to as a “level-4 table” (L4T) 540. Each L4E points to a level-3 table. The level-3 tables (L3 Ts) may be directory-pointer tables, for instance. Each L3T (e.g., L3T 542A, L3T 542B, etc.) contains at least one level-3 entry (L3E). Each L3E (e.g., L#E 3A, L3E 3B, etc.) points to a level-2 table. The level-2 tables (L2 Ts) may be directory tables, for instance. Each L2T (e.g., L2T 544A, L2T 544B, etc.) contains at least one level-2 entry (L2E). Each L2E (e.g., L2E 2A, L2E 2B, etc.) points to a level-1 table. The level-1 tables (L1Ts) may be supplemental UPM protection tables, for instance. Each L1T (e.g., L1T 546M, L1T 546M, etc.) includes a table or array of 2¹⁵ (32K) bits, with each bit indicating whether or not a corresponding page of physical memory is a secondary UPM region. Accordingly, each bit in an L1T may be referred to as a level-1 entry (LIE). The data in an L1T may also be referred to in general as “protection information” or more specifically as “protection bits.”

In one embodiment, each L4E, L3E, and L2E has the following format: bits 0-11 are reserved, bits 12-51 denote the base address of a table at the next higher level, and bits 52-63 are reserved. Thus, bits 12-51 in an L4E specify the base address of an L3T, bits 12-51 in an L3E specify the base address of an L2T, and bits 12-51 in an L2E specify the base address of an L1T.

The new SS determines which pages are to be used as secondary UPMRs, the new SS allocates those pages, and then the new SS updates secondary UPM catalog 560 to indicate that each of those pages is a secondary UPMR. The new SS also updates a SUCA register in TSC 513 in system agent 512 with a SUCA. In particular, in the embodiment of FIG. 8, the secondary UPM catalog starts with RSUT 540. Consequently, in the example of FIG. 8, the SUCA register may be referred to as an “RSUT address (RSUTA) register” 520. The new SS may update RSUTA register 520 with the address of the base of RSUT 540 (i.e., with RSUTA 522).

Also, as with other embodiments, when IOMMU 550 generates an IOMMU transaction, if UPM is enabled and the RTA in IOMMU 50 falls within primary UPMR 580, a personality assignment unit in TSC 552 in IOMMU 550 assigns a personality of “new.” Otherwise, the personality assignment unit in TSC 552 assigns a personality of “old.”

Also, in one embodiment, when system agent 512 receives an IOMMU transaction, a memory protection unit in TSC 513 determines if (a) UPM is enabled, (b) the transaction has a personality of “old,” and the transaction involves an address within a UPMR. If those conditions are met, the memory protection unit aborts or blocks the transaction. Otherwise, system agent 512 process the transaction. However, in another embodiment, a memory protection unit in TSC 552 in IOMMU 550 uses the same kind of approach to abort or block IOMMU transactions under the same kinds of conditions.

In addition, when system agent 512 receives a DMA request (e.g., DMA request 516), if UPM is not enabled, system agent 512 processes the request. However, if UPM is enabled, the memory protection unit in TSC 513 in system agent 512 performs various operations to determine whether to process the request or abort the request. For instance, the memory protection unit in TSC 513 in system agent 512 may split the target address 518 into multiple segments, and then use those segments as indexes or offsets into certain tables in secondary UPM catalog 560, to determine whether target address 518 falls in any UPMR. In particular, when determining whether the DMA request involves a UPMR, the memory protection unit uses secondary UPM catalog 560 in a manner similar to a multi-level page directory structure.

In particular, other embodiments may use different approaches, but in the embodiment of FIG. 8, the memory protection unit in TSC 513 splits target address 518 into five segments, depicted as segments S0-S4, with S0 denoting the low-order segment and S4 denoting the high-order segment. More specifically, the memory protection unit splits the bits in target address 518 into segments as follows:

| S4 | S3 | S2 | S1 | S0 |
|---|---|---|---|---|
| Up to 7 | 9 bits | 9 bits | 15 bits | 12 bits |
| bits (45-51) | (36-44) | (27-35) | (12-26) | (0-11) |

In the example of FIG. 8, when the memory protection unit in TSC 513 is determining whether a request involves a UPMR, the memory protection unit uses the URR in TSC 513 to determine whether the target address falls within primary UPMR 580. And if the target address does not fall within primary UPMR 580, the memory protection unit uses segments S0-S4 and RSUTA 522 to determining whether the target address falls within a secondary UPMR, based on secondary UPM catalog 560. That process may be referred to as a “page protection walk.” In particular, the memory protection unit may use a process such as the following:
S4 and RSUTA 522: use S4 as an offset from RSUTA 522 (i.e., from the base of RSUT 540) to select the L4E that corresponds to S4;
Extract the address of an L3T from that L4E;
S3: use S3 as an offset into that L3T to select the L3E that corresponds to S3;
Extract the address of an L2T from that L3E;
Use S2 as an offset into that L2T to select the L2E that corresponds to S2;
Extract the address of an L1T from that L2E;
Use S1 as an offset into that L1T to determine whether the bit at that offset denotes a protected page or an unprotected page (i.e., a secondary UPMR or a unprotected memory region).
Disregard S0.
   Accordingly, the dashed line in FIG. 8 indicates that RSUTA 522 points to the base of RSUT 540, and the various dotted lines show how the memory protection unit in TSC 513 combines segments from target address 518 with entries in secondary UPM catalog 560 to determine whether or not the target address falls within a secondary UPMR. In particular, FIG. 8 depicts a scenario in which S4 points to L4E 4B, which points to L3T 542B; S3 points to L3E 3B (in L3T 542B), which points to L2T 544B; S2 points to L2E 2B (in L2T 544B), which points to L1T 546M; and S1 points to the fourth bit in the bit array of L1T 546M. The new SS has set that bit. Consequently, the memory protection unit determines that the target address falls within a page (secondary UPMR 531B) that is protected as UPM. Also, in the scenario of FIG. 8, the first and third bits in L1T 546M are clear, indicating that the corresponding pages are unprotected memory regions, and the second bit is set, indicating that the corresponding page (i.e., secondary UPMR 531A) is protected as UPM.

As indicated above, each L1T contains 2¹⁵=32K L1Es, and each L1E covers one page. Consequently, each L1T (and each L2E) covers 32K pages. And since each page covers 4K, each L1T (and each L2E) covers a memory space of 128 megabytes (M) (32K*4K=128M).

Also, each L2T contains 2⁹=512 L2Es. Consequently, each L2T (and each L3E) covers a memory space of 64 gigabytes (GB) (128M*512).

Also, each L3T contains 2⁹=512 L3Es. Consequently, each L3T (and each L4E) covers a memory space of 32 terabytes (TB) (64 GB*512).

Also, L4T 540 contains 2⁷=128 L4Es. Consequently, L4T 540 can cover a memory space of 4 petabytes (PB) (32 TB*128).

In addition, when processing interrupts while UPM is enabled, the personality assignment unit in TSC 552 may assign a personality of “new” whenever an interrupt involves an IRTA that falls within any of the UPMRs. For instance, TSC 552 may include a shadow SUCA register that the personality assignment unit uses to consult secondary UPM catalog 560 to determine whether the IRTA falls within any UPMR. And the personality assignment unit may assign a personality of “new” whenever an interrupt involves an IRTA that falls within any of the UPMRs when UPM is enabled.

In any of the above embodiments, when the IOMMU is generating an IOMMU transaction while UPM is enabled, the personality assignment unit in the TSC in the IOMMU determines whether the current RTA falls within a UPMR. If the current RTA falls within a UPMR, the personality assignment unit assigns the personality of “new” to the transaction. Otherwise, the personality assignment unit assigns the personality of “old.”

And in one embodiment, when the system agent is processing an IOMMU transaction while UPM is enabled, if the transaction has a personality of “old,” the memory protection unit in the TSC in the system agent aborts or blocks the transaction. Otherwise, the memory protection unit in the system agent processes the transaction. And in another embodiment, the memory protection unit in the TSC in the IOMMU controls whether the IOMMU transaction is blocked or processed, based on the same criteria. Also, when the system agent is processing a DMA request while UPM is enabled, the memory protection unit in the TSC in the system agent determines whether the request involves a UPMR. If the request involves a UPMR, the memory protection unit in the TSC in the system agent blocks that request. Otherwise, the system agent processes the request.

In one embodiment, a data processing system uses features like those described above to perform the following operations:
1. The current/old SS enables UPMR(s).
   The system agent aborts or blocks all DMA requests attempting to touch UPMR(s).
   When the IOMMU generates an IOMMU transaction, if the transaction uses an RTA value that falls in a UPMR, the IOMMU assigns a personality of IOMMU-N to the transaction; otherwise the IOMMU assigns a personality of IOMMU-O.
2. The system agent or the IOMMU aborts or blocks any IOMMU transaction with the personality of IOMMU-O from touching UPMR(s) but allows IOMMU transactions with the personality of IOMMU-N to touch UPMR(s).
3. The new SS creates new page tables (DMATs) and IRTs in UPMR(s).
4. The new SS uses a command to switch the RTA to point to the new page tables in UPMR(s).
   All transactions related to DMA remapping with personality IOMMU-O are drained from the system to a global observation point and information related to IOMMU-O is flushed from DMA translation caches.
   All new page walks are IOMMU-N and hence allowed to touch UPMR(s).
5. If there are translation caches outside of the IOMMU, the new SS issues device translation lookaside buffer (DevTLB) invalidations and invalidation wait.
6. The new SS polls on a fence command (e.g., Invalidation_wait Status for Intel® Virtualization Technology for Directed I/O (VT-d)) to ensure that all DevTLB invalidations are complete.
7. The new SS uses a command to switch to new set of IRTs in UPMR(s).
   All transactions related to interrupt remapping with personality IOMMU-O are flushed from interrupt translation caches.
   All new interrupt walks are assigned the personality of IOMMU-N and hence are allowed to touch UPMR(s).
8. The new SS moves the IQ to UPMR(s).
   The new SS pauses/disables the IQ and changes the IQA register to point to the new location in UPMR(s).
   The new SS inserts a fence command (e.g., Invalidation_wait) as the first command in the new IQ to ensure that commands with personality IOMMU-O are complete.
   The new SS may copy over some/all descriptors from the old IQ into the new IQ.
   The new SS re-enables the IQ.
9. The new SS moves the OQ to UPMR(s).
   The new SS pauses the OQ and changes the OQ register to point to the new location in UPMR(s).
   The SS processes all commands from the old OQ.
   The new SS re-enables the OQ.
10. The new SS is now safe from old page tables, old IRTs, the old IQ, and the old OQ.
11. The new SS may then run normally.
12. The new SS disables UPMR(s).
   The system agent and the IOMMU allow IOMMU transactions to touch the area that used to be UPMR(s), whether those transactions have personality of IOMMU-N or IOMMU-O.
   When the IOMMU generates an IOMMU transaction, the IOMMU assigns a personality of IOMMU-O.
   The IOMMU is now working fully in the context of the page tables setup by the new SS, so there is no security issue in disabling the UPMR check.
13. The new SS issues a command to the IQ to drain IOMMU-N.
   This causes the IOMMU to drain all transactions with personality of IOMMU-N to a global-observation point.
14. The SS that is executing may now be considered to be the “current” or “old” SS. And when the system administrator decides to update the SS to a new version, the system administrator may use the current SS to enable a new UPMR(s), and the above process may be used to switch from the current SS to the new SS.

In another embodiment, a data processing system uses features like those in FIG. 6 and features like those in FIG. 8. Such a data processing system may include multiple URRs to identify multiple primary UPMRs, along with a secondary UPM catalog that can be distributed across one or more of those primary UPMRs.

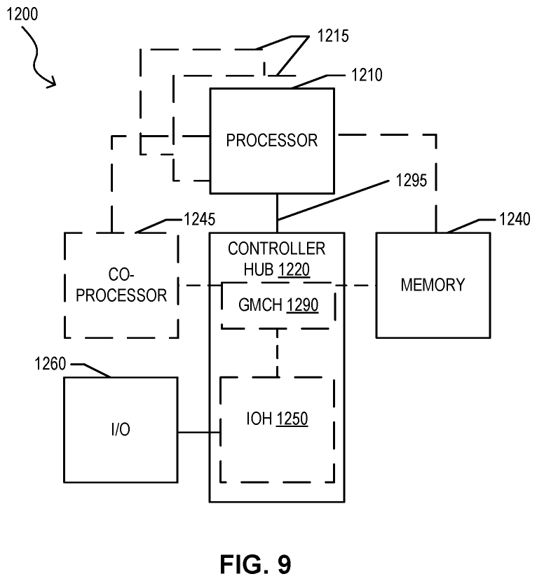

FIG. 9 is a block diagram of a system 1200 according to one or more embodiments. The system 1200 may include one or more processors 1210, 1215, which are coupled to a controller hub 1220. In one embodiment, the controller hub 1220 includes a graphics memory controller hub (GMCH) 1290 and an Input/Output Hub (IOH) 1250 (which may be on separate chips); the GMCH 1290 includes a memory controller to control operations within a coupled memory and a graphics controller to which are coupled memory 1240 and a coprocessor 1245; the IOH 1250 couples input/output (I/O) devices 1260 to the GMCH 1290. Alternatively, one or both of the memory and graphics controllers are integrated within the processor, the memory 1240 and the coprocessor 1245 are coupled directly to the processor 1210, and the controller hub 1220 is in a single chip with the IOH 1250.

The optional nature of additional processors 1215 is denoted in FIG. 9 with broken lines. Each processor 1210, 1215 may include one or more of the processing cores described herein and may be some version of the processor 1100.

The memory 1240 may be, for example, dynamic random-access memory (DRAM), phase change memory (PCM), or a combination of the two. For at least one embodiment, the controller hub 1220 communicates with the processor(s) 1210, 1215 via a multi-drop bus, such as a frontside bus (FSB), point-to-point interface such as QuickPath Interconnect (QPI), or similar connection 1295.

In one embodiment, the coprocessor 1245 is a special-purpose processor, such as, for example, a high-throughput MIC processor, a network or communication processor, compression engine, graphics processor, GPGPU, embedded processor, or the like. In one embodiment, controller hub 1220 may include an integrated graphics accelerator.

There can be a variety of differences between the physical resources 1210, 1215 in terms of a spectrum of metrics of merit including architectural, microarchitectural, thermal, power consumption characteristics, and the like.

In one embodiment, the processor 1210 executes instructions that control data processing operations of a general type. Embedded within the instructions may be coprocessor instructions. The processor 1210 recognizes these coprocessor instructions as being of a type that should be executed by the attached coprocessor 1245. Accordingly, the processor 1210 issues these coprocessor instructions (or control signals representing coprocessor instructions) on a coprocessor bus or other interconnect, to coprocessor 1245. Coprocessor(s) 1245 accept and execute the received coprocessor instructions.

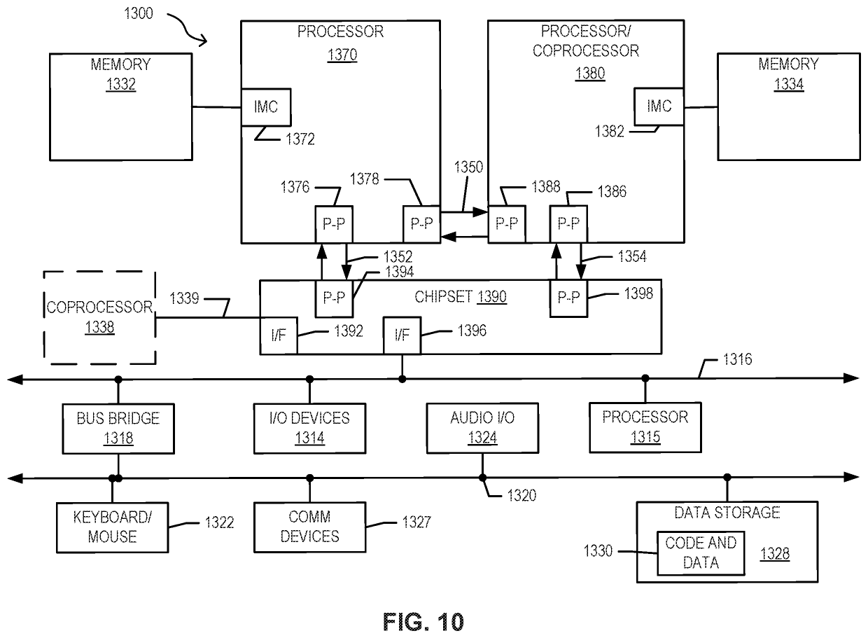

FIG. 10 is a block diagram of a first more specific exemplary system 1300 according to one or more embodiments. As shown in FIG. 10, multiprocessor system 1300 is a point-to-point interconnect system, and includes a first processor 1370 and a second processor 1380 coupled via a point-to-point interconnect 1350. Each of processors 1370 and 1380 may be some version of the processor 1100. In one embodiment, processors 1370 and 1380 are respectively processors 1210 and 1215, while coprocessor 1338 is coprocessor 1245. In another embodiment, processors 1370 and 1380 are respectively processor 1210 and coprocessor 1245.

Processors 1370 and 1380 are shown including integrated memory controller (IMC) units 1372 and 1382, respectively. Processor 1370 also includes as part of its bus controller units point-to-point (P-P) interfaces 1376 and 1378; similarly, second processor 1380 includes P-P interfaces 1386 and 1388. Processors 1370, 1380 may exchange information via a P-P interface 1350 using P-P interface circuits 1378, 1388. As shown in FIG. 10, IMCs 1372 and 1382 couple the processors to respective memories, namely a memory 1332 and a memory 1334, which may be portions of main memory locally attached to the respective processors.

Processors 1370, 1380 may each exchange information with a chipset 1390 via individual P-P interfaces 1352, 1354 using point to point interface circuits 1376, 1394, 1386, 1398. Chipset 1390 may optionally exchange information with the coprocessor 1338 via a high-performance interface 1339. In one embodiment, the coprocessor 1338 is a special-purpose processor, such as, for example, a high-throughput MIC processor, a network or communication processor, compression engine, graphics processor, GPGPU, embedded processor, or the like.

A shared cache (not shown) may be included in either processor or outside of both processors, yet connected with the processors via P-P interconnect, such that either or both processors' local cache information may be stored in the shared cache if a processor is placed into a low power mode.

Chipset 1390 may be coupled to a first bus 1316 via an interface 1396. In one embodiment, first bus 1316 may be a Peripheral Component Interconnect (PCI) bus, or a bus such as a PCI Express bus or another third generation I/O interconnect bus, although the scope of the present invention is not so limited.

As shown in FIG. 10, various I/O devices 1314 may be coupled to first bus 1316, along with a bus bridge 1318 which couples first bus 1316 to a second bus 1320. In one embodiment, one or more additional processors 1315, such as coprocessors, high-throughput MIC processors, GPGPUs, accelerators (such as, e.g., graphics accelerators or digital signal processing (DSP) units), field programmable gate arrays (FPGAs), or any other processor, are coupled to first bus 1316. In one embodiment, second bus 1320 may be a low pin count (LPC) bus. Various devices may be coupled to a second bus 1320 including, for example, a keyboard and/or mouse 1322, communication devices 1327 and a storage unit 1328 such as a disk drive or other mass storage device which may include instructions/code and data 1330, in one embodiment. Further, an audio I/O 1324 may be coupled to the second bus 1320. Note that other architectures are possible. For example, instead of the point-to-point architecture of FIG. 6, a system may implement a multi-drop bus or other such architecture.

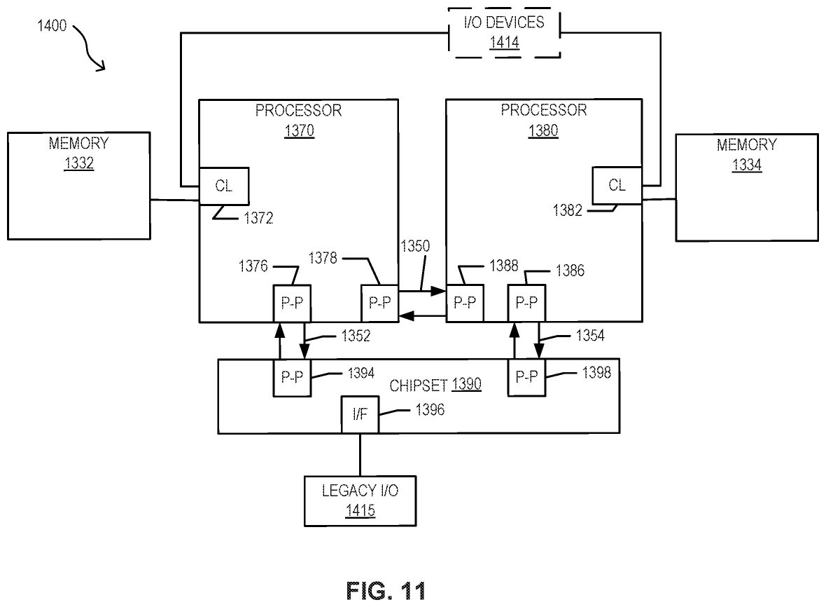

FIG. 11 is a block diagram of a second more specific exemplary system 1400 in accordance with on one or more embodiments. Certain aspects of FIG. 10 have been omitted from FIG. 11 in order to avoid obscuring other aspects of FIG. 11.

FIG. 11 illustrates that the processors 1370, 1380 may include integrated memory and I/O control logic (“CL”) 1372 and 1382, respectively. Thus, the CL 1372, 1382 include integrated memory controller units and include I/O control logic. FIG. 11 illustrates that not only are the memories 1332, 1334 coupled to the CL 1372, 1382, but also that I/O devices 1414 are also coupled to the control logic 1372, 1382. Legacy I/O devices 1415 are coupled to the chipset 1390.

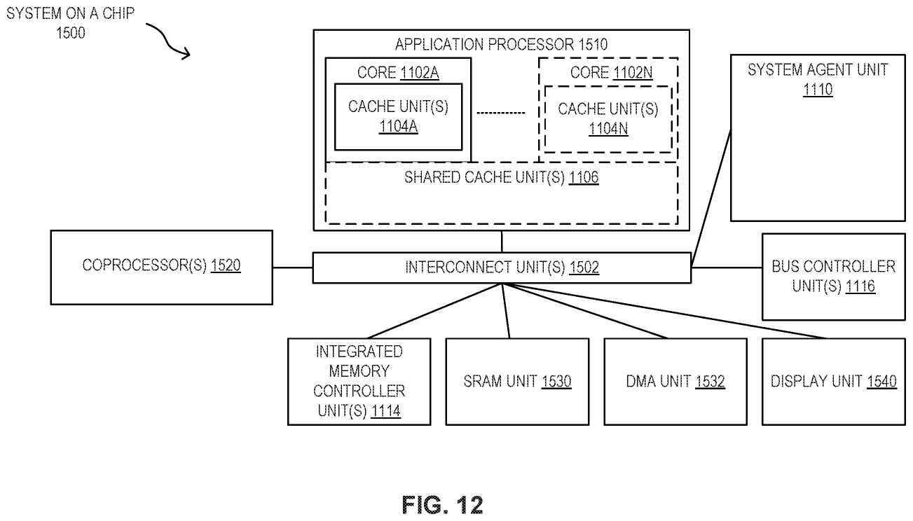

FIG. 12 is a block diagram of a system on a chip (SoC) 1500 according to one or more embodiments. Dashed lined boxes are optional features on more advanced SoCs. In FIG. 12, an interconnect unit(s) 1502 is coupled to: an application processor 1510 which includes a set of one or more cores 1102A-N (including constituent cache units 1104A-N) and shared cache unit(s) 1106; a system agent unit 1110; a bus controller unit(s) 1116; an integrated memory controller unit(s) 1114; a set or one or more coprocessors 1520 which may include integrated graphics logic, an image processor, an audio processor, and a video processor; an static random-access memory (SRAM) unit 1530; a direct memory access (DMA) unit 1532; and a display unit 1540 for coupling to one or more external displays. In one embodiment, the coprocessor(s) 1520 include a special-purpose processor, such as, for example, a network or communication processor, compression engine, GPGPU, a high-throughput MIC processor, embedded processor, security processor, or the like.

As has been described, a data processing system according to the present disclosure includes technology for efficiently and securely transferring IOMMU ownership from an old version of SS to a new version of SS. In particular, according to one embodiment, a data processing system establishes at least one region of UPM in the physical address space of the data processing system, and the data processing system may use that UPM region(s) to protect one or more data constructs (e.g., DMA tables) to be used by the new version of the SS. As indicated above, in one embodiment, a UPM region resides in (or is mapped to) RAM. Such RAM may include volatile RAM or non-volatile RAM. In addition or alternatively, a UPM region may reside in a portion of the physical address space that is mapped to a different storage medium. For instance, a UPM region may reside in a portion of the physical address space that is mapped to storage within a device via memory-mapped I/O (MMIO).

### CONCLUSION

In light of the principles and example embodiments described in the present disclosure by text and/or illustration, one with skill in the art will recognize that the described embodiments can be modified in arrangement and detail without departing from the principles described herein. Furthermore, This disclosure uses expressions such as “one embodiment” and “another embodiment” to describe embodiment possibilities. However, those expressions are not intended to limit the scope of this disclosure to particular embodiment configurations. For instance, those expressions may reference the same embodiment or different embodiments, and those different embodiments are combinable into other embodiments.

Additionally, the present teachings may be used to advantage in many different kinds of data processing systems. Such data processing systems may include, without limitation, mainframe computers, mini-computers, supercomputers, high-performance computing systems, computing clusters, distributed computing systems, personal computers (PCs), workstations, servers, client-server systems, portable computers, laptop computers, tablet computers, entertainment devices, audio devices, video devices, audio/video devices (e.g., televisions and set-top boxes), handheld devices, smartphones, telephones, personal digital assistants (PDAs), wearable devices, vehicular processing systems, accelerators, systems on a chip (SoCs), and other devices for processing and/or transmitting information. Accordingly, unless explicitly specified otherwise or required by the context, references to any particular type of data processing system (e.g., a PC) should be understood as encompassing other types of data processing systems, as well. A data processing system may also be referred to as an “apparatus.” The components of a data processing system may also be referred to as “apparatus.”

Also, according to the present disclosure, a device may include instructions and other data which, when accessed by a processor, cause the device to perform particular operations. For purposes of this disclosure, instructions or other data which cause a device to perform operations may be referred to in general as “software” or “control logic”. Software that is used during a boot process may be referred to as “firmware.” Software that is stored in non-volatile memory may also be referred to as “firmware.” Software may be organized using any suitable structure or combination of structures. Accordingly, terms like program and module may be used in general to cover a broad range of software constructs, including, without limitation, application programs, subprograms, routines, functions, procedures, drivers, libraries, data structures, processes, microcode, and other types of software components. Also, it should be understood that a software module may include more than one component, and those components may cooperate to complete the operations of the module. Also, the operations which the software causes a device to perform may include creating an operating context, instantiating a particular data structure, etc. Also, embodiments may include software that is implemented using any suitable operating environment and programming language (or combination of operating environments and programming languages). For example, program code may be implemented in a compiled language, in an interpreted language, in a procedural language, in an object-oriented language, in assembly language, in machine language, or in any other suitable language.

A medium which contains data and which allows another component to obtain that data may be referred to as a “machine-accessible medium” or a “machine-readable medium.” Accordingly, embodiments may include machine-readable media containing instructions for performing some or all of the operations described herein. Such media may be referred to in general as “apparatus” and in particular as “program products.” In one embodiment, software for multiple components may be stored in one machine-readable medium. In other embodiments, two or more machine-readable media may be used to store the software for one or more components. For instance, instructions for one component may be stored in one medium, and instructions another component may be stored in another medium. Or a portion of the instructions for one component may be stored in one medium, and the rest of the instructions for that component (as well instructions for other components), may be stored in one or more other media. Similarly, software that is described above as residing on a particular device in one embodiment may, in other embodiments, reside on one or more other devices. For instance, in a distributed environment, some software may be stored locally, and some may be stored remotely. The machine-readable media for some embodiments may include, without limitation, tangible non-transitory storage components such as magnetic disks, optical disks, magneto-optical disks, dynamic random-access memory (RAM), static RAM, non-volatile RAM (NVRAM), read-only memory (ROM), solid state drives (SSDs), phase change memory (PCM), etc., as well as processors, controllers, and other components that include data storage facilities. For purposes of this disclosure, the term “ROM” may be used in general to refer to non-volatile memory devices such as erasable programmable ROM (EPROM), electrically erasable programmable ROM (EEPROM), flash ROM, flash memory, etc.

Also, operations that are described as being performed on one particular device in one embodiment may, in other embodiments, be performed by one or more other devices. Also, although one or more example processes have been described with regard to particular operations performed in a particular sequence, numerous modifications could be applied to those processes to derive numerous alternative embodiments of the present invention. For example, alternative embodiments may include processes that use fewer than all of the disclosed operations, processes that use additional operations, and processes in which the individual operations disclosed herein are combined, subdivided, rearranged, or otherwise altered.

It should also be understood that the hardware and software components depicted herein represent functional elements that are reasonably self-contained so that each can be designed, constructed, or updated substantially independently of the others. In alternative embodiments, components may be implemented as hardware, software, or combinations of hardware and software for providing the functionality described and illustrated herein. For instance, in some embodiments, some or all of the control logic for implementing the described functionality may be implemented in hardware logic circuitry, such as with an application-specific integrated circuit (ASIC) or with a programmable gate array (PGA). Similarly, some or all of the control logic may be implemented as microcode in an integrated circuit chip. Also, terms such as “circuit” and “circuitry” may be used interchangeably herein. Those terms and terms like “logic” may be used to refer to analog circuitry, digital circuitry, processor circuitry, microcontroller circuitry, hardware logic circuitry, hard-wired circuitry, programmable circuitry, state machine circuitry, any other type of hardware component, or any suitable combination of hardware components.

Also, unless expressly specified otherwise, components that are described as being coupled to each other, in communication with each other, responsive to each other, or the like need not be in continuous communication with each other and need not be directly coupled to each other. Likewise, when one component is described as receiving data from or sending data to another component, that data may be sent or received through one or more intermediate components, unless expressly specified otherwise. In addition, some components of the data processing system may be implemented as adapter cards with interfaces (e.g., a connector) for communicating with a bus. Alternatively, devices or components may be implemented as embedded controllers, using components such as programmable or non-programmable logic devices or arrays, ASICs, embedded computers, smart cards, and the like. For purposes of this disclosure, the term “bus” includes pathways that may be shared by more than two devices, as well as point-to-point pathways. Similarly, terms such as “line,” “pin,” etc. should be understood as referring to a wire, a set of wires, or any other suitable conductor or set of conductors. For instance, a bus may include one or more serial links, a serial link may include one or more lanes, a lane may be composed of one or more differential signaling pairs, and the changing characteristics of the electricity that those conductors are carrying may be referred to as “signals.” Also, for purpose of this disclosure, the term “processor” denotes a hardware component that is capable of executing software. For instance, a processor may be implemented as a central processing unit (CPU) or as any other suitable type of processing element. A CPU may include one or more processing cores. And a device may include one or more processors.

Other embodiments may be implemented in data and may be stored on a non-transitory storage medium, which if used by at least one machine, causes the at least one machine to fabricate at least one integrated circuit to perform one or more operations according to the present disclosure. Still further embodiments may be implemented in a computer-readable storage medium including information that, when manufactured into an SoC or other processor, is to configure the SoC or other processor to perform one or more operations according to the present disclosure. One or more aspects of at least one embodiment may be implemented by representative instructions, stored on a machine-readable medium, which represent various logic units within the processor, and which, when read by a machine, cause the machine to fabricate logic units to perform the techniques described herein. The instructions representing various logic units may be referred to as “IP cores,” and they may be stored on a tangible, machine-readable medium and supplied to various customers or manufacturing facilities to load into the fabrication machines that actually make the logic units or the processor. One or more aspects of at least one embodiment may include machine-readable media containing instructions or design data which defines structures, circuits, apparatuses, processors and/or system features described herein. For instance, design data may be formatted in a hardware description language (HDL).

Embodiments include the following examples:

Example A1 is a processor package comprising a processing core, a system agent in communication with the processing core, an IOMMU in communication with the system agent, and TSC in at least one component from the group consisting of the IOMMU and the system agent. The TSC is to determine whether UPM is enabled in a data processing system that comprises the processor package; determine whether an address for a memory access transaction in the data processing system falls within a UPM region within a physical address space of the data processing system; and block the memory access transaction, in response to a determination that (a) UPM is enabled and (b) the address for the memory access transaction falls within the UPM region.

Example A2 is a processor package according to Example A1, wherein the memory access transaction comprises an IOMMU transaction. Also, the TSC comprises a personality assignment unit to assign a transaction personality of old to the IOMMU transaction, in response to a determinination from the group consisting of (a) a determination that UPM is not enabled in the data processing system and (b) a determinination that an address in an RTA register in the processor package does not fall within the UPM region. The TSC also comprises a memory protection unit to determine (a) whether UPM is enabled in the data processing system, (b) whether the address for the IOMMU transaction falls within the UPM region, and (c) whether the IOMMU transaction has the transaction personality of old; and to block the IOMMU transaction, in response to a determination that (a) UPM is enabled, (b) the address for the IOMMU transaction falls within the UPM region, and (c) the IOMMU transaction has the transaction personality of old.

Example A3 is a processor package according to Example A2, wherein the IOMMU comprises the personality assignment unit.

Example A4 is a processor package according to Example A1, wherein the memory access transaction comprises a DMA transaction. Also, the TSC comprises a memory protection unit to determine (a) whether UPM is enabled in the data processing system and (b) whether the address for the DMA transaction falls within the UPM region; and to block the DMA transaction, in response to a determination that (a) UPM is enabled and (b) the address for the IOMMU transaction falls within the UPM region. Example A4 may also include the features of any one or more of Examples A2-A3.

Example A5 is a processor package according to Example A4, wherein the system agent comprises the memory protection unit.

Example A6 is a processor package according to Example A1, wherein the TSC comprises a UPM range register which enables system software to specify the UPM region within the physical address space of the data processing system, and at least part of the physical address space is mapped to RAM in the data processing system. Example A6 may also include the features of any one or more of Examples A2-A5.

Example A7 is a processor package according to Example A1, wherein the TSC comprises a UPM range register to define a primary UPM region, and a SUCA register to contain an address of a secondary UPM catalog to define at least one secondary UPM region. Example A7 may also include the features of any one or more of Examples A2-A6.

Example A8 is a processor package according to Example A7, wherein the TSC is to use the address for the memory access transaction as an index into the secondary UPM catalog, to obtain protection information for the address from the secondary UPM catalog. The TSC is also to determine whether the address falls within any secondary UPM region, based on the protection information for the address from the secondary UPM catalog; and to determine whether to block the memory access transaction, based on the determination of whether the address falls within any secondary UPM region.

Example A9 is a processor package according to Example A8, wherein the secondary catalog comprises multiple tables that are linked hierarchically.

Example A10 is a processor package according to Example A1, wherein the TSC enables a system administrator to transfer control of the data processing system from an old version of system software to a new version of system software without rebooting the data processing system. Example A10 may also include the features of any one or more of Examples A1-A8.

Example A11 is a processor package according to Example A10, wherein the TSC enables an input queue and an output quque to be transferred from the old version of system software to the new version of system software without rebooting the data processing system.

Example B1 is a data processing system comprising a processor package and a storage medium to be accessible to the processor package via a physical address space of the data processing system. The data processing system also comprises TSC in the processor package to determine whether UPM is enabled in the data processing system; determine whether an address for a memory access transaction in the data processing system falls within a UPM region in the physical address space; and block the memory access transaction, in response to a determination that (a) UPM is enabled and (b) the address for the memory access transaction falls within the UPM region.

Example B2 is a data processing system according to Example B1, wherein the memory access transaction comprises an IOMMU transaction. Also, the TSC comprises a personality assignment unit to assign a transaction personality of old to the IOMMU transaction, in response to a determinination from the group consisting of (a) a determination that UPM is not enabled in the data processing system and (b) a determination that an address in an RTA register in the processor package does not fall within the UPM region. The TSC also comprises a memory protection unit to determine (a) whether UPM is enabled in the data processing system, (b) whether the address for the IOMMU transaction falls within the UPM region, and (c) whether the IOMMU transaction has the transaction personality of old; and to block the IOMMU transaction, in response to a determination that (a) UPM is enabled, (b) the address for the IOMMU transaction falls within the UPM region, and (c) the IOMMU transaction has the transaction personality of old.

Example B3 is a data processing system according to Example B2, wherein the processor package comprises a processing core and an IOMMU, and the IOMMU comprises the personality assignment unit.

Example B4 is a data processing system according to Example B1, wherein the memory access transaction comprises a DMA transaction. Also, the TSC comprises a memory protection unit to determine (a) whether UPM is enabled in the data processing system and (b) whether the address for the DMA transaction falls within the UPM region; and to block the DMA transaction, in response to a determination that (a) UPM is enabled and (b) the address for the IOMMU transaction falls within the UPM region. Example B4 may also include the features of any one or more of Examples B1-B3.

Example B5 is a data processing system according to Example B4, wherein the processor package comprises a processing core and a system agent, and the system agent comprises the memory protection unit.

Example B6 is a data processing system according to Example B1, wherein the TSC comprises a UPM range register to define a primary UPM region, and a SUCA register to contain an address of a secondary UPM catalog to define at least one secondary UPM region. Example B6 may also include the features of any one or more of Examples B2-B5.

Example B7 is a data processing system according to Example B6, wherein the TSC is to use the address for the memory access transaction as an index into the secondary UPM catalog, to obtain protection information for the address from the secondary UPM catalog; determine whether the address falls within any secondary UPM region, based on the protection information for the address from the secondary UPM catalog; and determine whether to block the memory access transaction, based on the determination of whether the address falls within any secondary UPM region.

Example C1 is a method to protect memory of a data processing system. The method comprises determining, in a processor package in a data processing system, whether UPM is enabled in the data processing system; determining, in the processor package, whether an address for a memory access transaction in the data processing system falls within a UPM region within a physical address space of the data processing system; and blocking the memory access transaction, in response to a determination that (a) UPM is enabled and (b) the address for the memory access transaction falls within the UPM region.

Example C2 is a method according to Example C1, further comprising updating TSC in the processor package to specify the UPM region within the physical address space of the data processing system; enabling UPM; launching a new version of system software in the data processing system; and after enabling UPM and launching the new version of the system software, (a) storing a new version of a DMA table in the UPM region, and (b) storing an address for the new version of the DMA table in an RTA register in the processor package.

Example C3 is a method according to Example C2, wherein the operations of updating the TSC to specify the UPM region and enabling UPM are performed by an old version of the system software before the new version of the system software is launched. Also, the old version of the system software locates the UPM region in a portion of the physical address space that does not contain any DMA tables.

Example C4 is a method according to Example C1, further comprising updating TSC in the processor package to specify the UPM region within the physical address space of the data processing system; enabling UPM; after updating the TSC to specify the UPM region and enabling UPM, launching a new version of system software in the data processing system; before launching the new version of the system software, storing, in the UPM region, a new version of a DMA table to be used by the new version of the system software; and after launching the new version of the system software, storing an address for the new version of the DMA table in an RTA register in the processor package. Also, the operation of storing the new version of the DMA table in the UPM region is performed while a virtual machine is executing in the data processing system under an old version of the system software. Example C4 may also include the features of any one or more of Examples C2-C3.

Example C5 is a method according to Example C1, wherein the memory access transaction comprises an IOMMU transaction. Also, the method further comprises assigning a transaction personality of old to the IOMMU transaction, in response to a determinination that UPM is not enabled in the data processing system; determining (a) whether UPM is enabled in the data processing system, (b) whether the address for the IOMMU transaction falls within the UPM region, and (c) whether the IOMMU transaction has the transaction personality of old; and blocking the IOMMU transaction, in response to a determination that (a) UPM is enabled, (b) the address for the IOMMU transaction falls within the UPM region, and (c) the IOMMU transaction has the transaction personality of old. Example C5 may also include the features of any one or more of Examples C1-C4.

Example C6 is a method according to Example C1, wherein the memory access transaction comprises a DMA transaction. Also, the method further comprises determining (a) whether UPM is enabled in the data processing system and (b) whether the address for the DMA transaction falls within the UPM region; and blocking the DMA transaction, in response to a determination that (a) UPM is enabled and (b) the address for the IOMMU transaction falls within the UPM region. Example C6 may also include the features of any one or more of Examples C2-C5.

Example C7 is a method according to Example C1, further comprising specifying multiple UPM regions within RAM of the data processing system. Also, the operation of determining whether the address for the memory access transaction falls within the UPM region comprises determining whether the address for the memory access transaction falls within any of the UPM regions.

Example D1 is an apparatus comprising a computer-readable medium and instructions in the computer-readable medium which, when executed by a data processing system that supports UPM, cause the data processing system to update TSC in a processor package in the data processing system to define a UPM region within a physical address space of the data processing system. The instructions, when executed, also cause the data processing system to (a) enable UPM, (b) in response to detecting a memory access transaction while UPM is enabled, determine whether an address for the memory access transaction falls within the UPM region, and (c) in response to determining that the address for the memory access transaction falls within the UPM region while UPM is enabled, block the memory access transaction.

Example D2 is an apparatus according to Example D1, wherein the instruction further cause the data processing system to (a) launch a new version of system software in the data processing system; and (b) after enabling UPM and launching the new version of the system software, (i) store a new version of a DMA table in the UPM region, and (ii) store an address for the new version of the DMA table in an RTA register in the processor package.

Example D3 is an apparatus according to Example D2, wherein the instructions comprise an old version of the system software which, when executed, causes the data processing system to perform the operations of updating the TSC to define the UPM region and enabling UPM. Also, the old version of the system software, when executed, further causes the data processing system to (a) locate the UPM region in a portion of the physical address space that does not contain any DMA tables, and (b) launch the new version of the system software after updating the TSC to define the UPM region and enabling UPM.

Example D4 is an apparatus according to Example D1, wherein the instructions comprise an old version of the system software which, when executed, causes the data processing system to (a) execute a VM under the old version of the system software, and (b) while executing the VM under the old version of the system software, and before launching a new version of the system software, store, in the UPM region, a new version of a DMA table to be used by the new version of the system software. Example D4 may also include the features of any one or more of Examples D2-D3.

Example D5 is an apparatus according to Example D1, wherein the memory access transaction comprises an IOMMU transaction, and the instructions, when executed, cause the data processing system to assign a transaction personality of old to the IOMMU transaction, in response to a determinination that UPM is not enabled in the data processing system. The instructions, when executed, also cause the data processing system to determine (a) whether UPM is enabled in the data processing system, (b) whether the address for the IOMMU transaction falls within the UPM region, and (c) whether the IOMMU transaction has the transaction personality of old. The instructions, when executed, also cause the data processing system to block the IOMMU transaction, in response to a determination that (a) UPM is enabled, (b) the address for the IOMMU transaction falls within the UPM region, and (c) the IOMMU transaction has the transaction personality of old. Example D5 may also include the features of any one or more of Examples D2-D4.

Example D6 is an apparatus according to Example D1, wherein the memory access transaction comprises a DMA transaction, and the instructions, when executed, cause the data processing system to determine (a) whether UPM is enabled in the data processing system and (b) whether the address for the DMA transaction falls within the UPM region. The instructions, when executed, also cause the data processing system to block the DMA transaction, in response to a determination that (a) UPM is enabled and (b) the address for the IOMMU transaction falls within the UPM region. Example D6 may also include the features of any one or more of Examples D2-D5.

Example D7 is an apparatus according to Example D1, wherein the instructions, when executed, cause the data processing system to define multiple UPM regions within RAM of the data processing system. Also, the operation of determining whether the address for the memory access transaction falls within the UPM region comprises determining whether the address for the memory access transaction falls within any of the UPM regions. Example D7 may also include the features of any one or more of Examples D2-D6.

In view of the wide variety of useful permutations that may be readily derived from the example embodiments described herein, this detailed description is intended to be illustrative only, and should not be construed as limiting the scope of coverage.

1. A processor package comprising:
a processing core;
a system agent in communication with the processing core;
an input/output memory management unit (IOMMU) in communication with the system agent; and
transaction security circuitry (TSC) in at least one component from the group consisting of the IOMMU and the system agent, the TSC to:
determine whether ultra-protected memory (UPM) is enabled in a data processing system that comprises the processor package;
determine whether an address for a memory access transaction in the data processing system falls within a UPM region within a physical address space of the data processing system; and
block the memory access transaction, in response to a determination that (a) UPM is enabled and (b) the address for the memory access transaction falls within the UPM region.

2. A processor package according to claim 1, wherein the memory access transaction comprises an input/output memory management unit (IOMMU) transaction, and the TSC comprises:
a personality assignment unit to assign a transaction personality of old to the IOMMU transaction, in response to a determination from the group consisting of:
a determination that UPM is not enabled in the data processing system; and
a determination that an address in a root table address (RTA) register in the processor package does not fall within the UPM region; and
a memory protection unit to determine (a) whether UPM is enabled in the data processing system, (b) whether the address for the IOMMU transaction falls within the UPM region, and (c) whether the IOMMU transaction has the transaction personality of old, and to block the IOMMU transaction, in response to a determination that (a) UPM is enabled, (b) the address for the IOMMU transaction falls within the UPM region, and (c) the IOMMU transaction has the transaction personality of old.

3. A processor package according to claim 2, wherein the IOMMU comprises the personality assignment unit.

4. A processor package according to claim 1, wherein the memory access transaction comprises a direct memory access (DMA) transaction, and the TSC comprises:
a memory protection unit to determine (a) whether UPM is enabled in the data processing system and (b) whether the address for the DMA transaction falls within the UPM region, and to block the DMA transaction, in response to a determination that (a) UPM is enabled and (b) the address for the DMA transaction falls within the UPM region.

5. A processor package according to claim 4, wherein the system agent comprises the memory protection unit.

6. A processor package according to claim 1, wherein:
the TSC comprises a UPM range register which enables system software to specify the UPM region within the physical address space of the data processing system; and
at least part of the physical address space is mapped to random access memory (RAM) in the data processing system.

7. A processor package according to claim 1, wherein the TSC comprises:
a UPM range register to define a primary UPM region; and
a secondary UPM catalog address (SUCA) register to contain an address of a secondary UPM catalog to define at least one secondary UPM region.

8. A processor package according to claim 7, wherein the TSC is to:
use the address for the memory access transaction as an index into the secondary UPM catalog, to obtain protection information for the address from the secondary UPM catalog;
determine whether the address falls within any secondary UPM region, based on the protection information for the address from the secondary UPM catalog; and
determine whether to block the memory access transaction, based on the determination of whether the address falls within any secondary UPM region.

9. A processor package according to claim 8, wherein the secondary catalog comprises multiple tables that are linked hierarchically.

10. A processor package according to claim 1, wherein the TSC enables a system administrator to transfer control of the data processing system from an old version of system software to a new version of system software without rebooting the data processing system.

11. A processor package according to claim 10, wherein the TSC enables an input queue and an output queue to be transferred from the old version of system software to the new version of system software without rebooting the data processing system.

12. A data processing system comprising:
a processor package;
a storage medium to be accessible to the processor package via a physical address space of the data processing system; and
transaction security circuitry (TSC) in the processor package to:
determine whether ultra-protected memory (UPM) is enabled in the data processing system;
determine whether an address for a memory access transaction in the data processing system falls within a UPM region in the physical address space; and
block the memory access transaction, in response to a determination that (a) UPM is enabled and (b) the address for the memory access transaction falls within the UPM region.

13. A data processing system according to claim 12, wherein the memory access transaction comprises an input/output memory management unit (IOMMU) transaction, and the TSC comprises:
a personality assignment unit to assign a transaction personality of old to the IOMMU transaction, in response to a determination from the group consisting of:
a determination that UPM is not enabled in the data processing system; and
a determination that an address in a root table address (RTA) register in the processor package does not fall within the UPM region; and
a memory protection unit to determine (a) whether UPM is enabled in the data processing system, (b) whether the address for the IOMMU transaction falls within the UPM region, and (c) whether the IOMMU transaction has the transaction personality of old, and to block the IOMMU transaction, in response to a determination that (a) UPM is enabled, (b) the address for the IOMMU transaction falls within the UPM region, and (c) the IOMMU transaction has the transaction personality of old.

14. A data processing system according to claim 13, wherein:
the processor package comprises a processing core and an IOMMU; and
the IOMMU comprises the personality assignment unit.

15. A data processing system according to claim 12, wherein the memory access transaction comprises a direct memory access (DMA) transaction, and the TSC comprises:
a memory protection unit to determine (a) whether UPM is enabled in the data processing system and (b) whether the address for the DMA transaction falls within the UPM region, and to block the DMA transaction, in response to a determination that (a) UPM is enabled and (b) the address for the DMA transaction falls within the UPM region.

16. A data processing system according to claim 15, wherein:
the processor package comprises a processing core and a system agent; and
the system agent comprises the memory protection unit.

17. A data processing system according to claim 12, wherein the TSC comprises:
a UPM range register to define a primary UPM region; and
a secondary UPM catalog address (SUCA) register to contain an address of a secondary UPM catalog to define at least one secondary UPM region.

18. A data processing system according to claim 17, wherein the TSC is to:
use the address for the memory access transaction as an index into the secondary UPM catalog, to obtain protection information for the address from the secondary UPM catalog;
determine whether the address falls within any secondary UPM region, based on the protection information for the address from the secondary UPM catalog; and
determine whether to block the memory access transaction, based on the determination of whether the address falls within any secondary UPM region.

19. An apparatus comprising:
a computer-readable medium; and
instructions in the computer-readable medium which, when executed by a data processing system that supports ultra-protected memory (UPM), cause the data processing system to:
update transaction security circuitry (TSC) in a processor package in the data processing system to define a UPM region within a physical address space of the data processing system;
enable UPM;
in response to detecting a memory access transaction while UPM is enabled, determine whether an address for the memory access transaction falls within the UPM region; and
in response to determining that the address for the memory access transaction falls within the UPM region while UPM is enabled, block the memory access transaction.

20. An apparatus according to claim 19, wherein the instructions further cause the data processing system to:
launch a new version of system software in the data processing system; and
after enabling UPM and launching the new version of the system software, (a) store a new version of a direct memory access (DMA) table in the UPM region, and (b) store an address for the new version of the DMA table in a root table address (RTA) register in the processor package.

21. An apparatus according to claim 20, wherein the instructions comprise:
an old version of the system software which, when executed, causes the data processing system to perform the operations of updating the TSC to define the UPM region and enabling UPM; and
the old version of the system software, when executed, further causes the data processing system to:
locate the UPM region in a portion of the physical address space that does not contain any DMA tables; and
launch the new version of the system software after updating the TSC to define the UPM region and enabling UPM.

22. An apparatus according to claim 19, wherein the instructions comprise an old version of the system software which, when executed, causes the data processing system to:
execute a virtual machine (VM) under the old version of the system software; and
while executing the VM under the old version of the system software, and before launching a new version of the system software, store, in the UPM region, a new version of a direct memory access (DMA) table to be used by the new version of the system software.

23. An apparatus according to claim 19, wherein the memory access transaction comprises an input/output memory management unit (IOMMU) transaction, and the instructions, when executed, cause the data processing system to:
assign a transaction personality of old to the IOMMU transaction, in response to a determination that UPM is not enabled in the data processing system;
determine (a) whether UPM is enabled in the data processing system, (b) whether the address for the IOMMU transaction falls within the UPM region, and (c) whether the IOMMU transaction has the transaction personality of old; and
block the IOMMU transaction, in response to a determination that (a) UPM is enabled, (b) the address for the IOMMU transaction falls within the UPM region, and (c) the IOMMU transaction has the transaction personality of old.

24. An apparatus according to claim 19, wherein the memory access transaction comprises a direct memory access (DMA) transaction, and the instructions, when executed, cause the data processing system to:
determine (a) whether UPM is enabled in the data processing system and (b) whether the address for the DMA transaction falls within the UPM region; and
block the DMA transaction, in response to a determination that (a) UPM is enabled and (b) the address for the DMA transaction falls within the UPM region.

25. An apparatus according to claim 19, wherein the instructions, when executed, cause the data processing system to:
define multiple UPM regions within random access memory (RAM) of the data processing system; and
wherein the operation of determining whether the address for the memory access transaction falls within the UPM region comprises determining whether the address for the memory access transaction falls within any of the UPM regions.
